(19) United States
(12) Patent Application Publication
(10) Pub. No.: US 2018/0047519 A1
(43) Pub. Date: Feb. 15, 2018

(54) GRAPHENE NANORIBBON-BASED MATERIALS AND THEIR USE IN ELECTRONIC DEVICES

(71) Applicant: WILLIAM MARSH RICE UNIVERSITY, Houston, TX (US)

(72) Inventors: James M. Tour, Bellaire, TX (US); Rodrigo V. Salvatierra, Houston, TX (US); Abdul-Rahman O. Raji, Houston, TX (US)

(73) Assignee: William Marsh Rice University, Houston, TX (US)

(21) Appl. No.: 15/556,783

(22) PCT Filed: Mar. 9, 2016
(86) PCT No.: PCT/US2016/021567

§ 371 Date: Sep. 8, 2017

Related U.S. Application Data
(60) Provisional application No. 62/130,093, filed on Mar. 9, 2015.

(51) Int. Cl. H01G 11/36; H01G 11/26; H01G 11/50; H01M 4/133; H01M 4/1393; C01B 33/02; H01M 4/505; H01M 4/58; H01M 4/48; H01M 4/62; C01B 32/182; H01G 11/86; H01M 4/525

(52) U.S. Cl. CPC H01G 11/36; H01G 11/86; H01G 11/26; H01G 11/50; H01M 4/133; H01M 4/1393; H01M 4/525; H01M 4/505; H01M 4/5825; H01M 4/483; H01M 4/625; C01B 32/182; C01B 33/02; C01B 2204/06; C01B 2204/22; C01P 2006/40; C01P 2004/16

(57) ABSTRACT

Embodiments of the present disclosure pertain to methods of making electrically conductive materials by applying nanowires and graphene nanoribbons onto a surface to form a network layer with interconnected graphene nanoribbons and nanowires. In some embodiments, the methods include the following steps: (a) applying graphene nanoribbons onto a surface to form a graphene nanoribbon layer; (b) applying nanowires and graphene nanoribbons onto the graphene nanoribbon layer to form the network layer; and (c) optionally applying graphene nanoribbons onto the formed network layer to form a second graphene nanoribbon layer on the network layer. Additional embodiments of the present disclosure pertain to the formed electrically conductive materials and their use as components of electronic devices, such as energy storage devices. Further embodiments of the present disclosure pertain to electronic devices that contain the electrically conductive materials of the present disclosure.

### CROSS-REFERENCE TO RELATED APPLICATIONS

This application claims priority to U.S. Provisional Patent Application No. 62/130,093, filed on Mar. 9, 2015. The entirety of the aforementioned application is incorporated herein by reference.

### STATEMENT REGARDING FEDERALLY SPONSORED RESEARCH

This invention was made with government support under Grant No. FA9550-14-1-0111, awarded by the U.S. Department of Defense. The government has certain rights in the invention.

### BACKGROUND

Current electronic devices suffer from numerous limitations, including limited capacity, limited power, high net weights, and limited life cycles. Various aspects of the present disclosure address the aforementioned limitations.

### SUMMARY

In some embodiments, the present disclosure pertains to methods of making an electrically conductive material. In some embodiments, the methods of the present disclosure include a step of applying nanowires and graphene nanoribbons onto a surface to form a network layer with interconnected graphene nanoribbons and nanowires. In some embodiments, the methods of the present disclosure include the following steps: (a) applying graphene nanoribbons onto a surface to form a graphene nanoribbon layer; (b) applying nanowires and graphene nanoribbons onto the graphene nanoribbon layer to form a network layer with interconnected graphene nanoribbons and nanowires; and (c) optionally applying graphene nanoribbons onto the formed network layer to form a second graphene nanoribbon layer on the network layer.

Additional embodiments of the present disclosure pertain to the formed electrically conductive materials. The electrically conductive materials of the present disclosure generally include a network layer with interconnected graphene nanoribbons and nanowires. In some embodiments, the electrically conductive material also includes a graphene nanoribbon layer associated with a surface of the network layer. In some embodiments, the electrically conductive material also includes a second graphene nanoribbon layer associated with an opposite surface of the network layer.

The electrically conductive materials of the present disclosure can have various advantageous electronic properties. For instance, in some embodiments, the electrically conductive materials of the present disclosure have gravimetric energy storage capacities of more than about 500 mAh g⁻¹, areal energy storage capacities ranging from about 1 mAh cm⁻² to about 10 mAh cm⁻², volumetric energy storage capacities ranging from about 500 mAh cm⁻³ to about 4,000 mAh cm³, and conductivities ranging from about 250 nS m⁻¹ to about 3,000 nS m⁻¹.

As such, in some embodiments, the electrically conductive materials of the present disclosure can be utilized as components of various electronic devices, such as energy storage devices. Additional embodiments of the present disclosure pertain to electronic devices that contain the electrically conductive materials of the present disclosure.

In some embodiments, the electrically conductive materials of the present disclosure are utilized as an electrode. In some embodiments, the network layer serves as the active layer of the electrode. In some embodiments, the electrically conductive material also includes a graphene nanoribbon layer that serves as the current collector of the electrode.

Electronic devices that contain the electrically conductive materials of the present disclosure can also have various advantageous properties. For instance, in some embodiments, energy storage devices that contain the electrically conductive materials of the present disclosure have energy densities of more than about 400 Wh.kg⁻¹, operation voltages of more than about 1 V (e.g., operating voltages ranging from about 1 V to about 5V in a single cell, and to more than about 10 V in a pack), and conversion efficiencies of more than about 75%.

### DESCRIPTION OF THE FIGURES

FIG. 1 illustrates the formation of electrically conductive materials (FIG. 1A), the structures of the formed materials (FIGS. 1B-D), and the use of the formed materials as electrodes in a battery (FIG. 1E).

FIG. 2 provides a scheme for the preparation of porous silicon nanowire (Si-NW)/graphene nanoribbon (GNR) papers (Si-NW/GNR papers, FIG. 2A) and related images (FIGS. 2B-G). FIG. 2B provides a scanning electron microscope (SEM) image of the Si-NW forest on the Si wafer before Si-NW removal. FIG. 2C provides an SEM image of the pure GNR paper. FIG. 2D provides an SEM image (top-view) of the hybrid Si-NW/GNR paper. FIGS. 2E-F provide SEM images of a bottom-view of the Si-NW/GNR paper. FIG. 2G provides a cross-section SEM image of the Si-NW/GNR paper. The inset of FIG. 2G is a line scan mapping by energy dispersive X-ray spectroscopy (EDAX) of C, Si and O across the film (scan direction is presented in the figure as a dotted line).

FIG. 3 provides SEM images that illustrate the formation of Si-NWs through the repeated use of Si wafers.

FIG. 4 provides data relating to the characterization of Si-NW/GNR papers. FIG. 4A provides X-ray diffractograms of Si-NWs, GNRs and Si-NW/GNR papers. FIG. 4B provides Raman spectra of the materials at 514.5 nm excitation.

FIG. 5 provides additional images relating to Si-NW/GNR papers. FIG. 5A shows a transmission electron microscopy (TEM) image of GNRs. FIG. 5B shows a TEM image of Si-NWs on a carbon grid. FIG. 5C shows a TEM image of contact points between GNRs and Si-NWs. FIGS. 5D-E show high magnification TEM images of the porous structures of Si-NWs. The inset in FIG. 5E represents the spacing of (111) planes of Si. FIG. 5F shows a selected area electron diffraction (SAED) of a Si-NW and the corresponding planes.

FIG. 6 provides data relating to current-potential measurements for Si-NW/GNR papers. FIG. 6A provides a scheme of the current-potential testing of Si-NW/GNR papers. The top part of the electrode was covered by evaporated platinum (thickness t=40 nm) in several points over the electrode, while the bottom part of the electrode was covered with evaporated nickel (continuous films, with thickness t=40 nm). Current-potential tests were conducted between the bottom contact (metal foil) and the top contact (Ni over the Si-NW/GNR). The optical images show the electrodes used to test current and potential in the different points. FIG. 6B provides distribution curves obtained from the different measurements at different points. Gaussian fit (red dashed curve) was used to estimate the average conductivity (1280 nS m⁻¹).

FIG. 7 provides current-potential curves of the Si-NW/GNR paper shown in FIG. 6. The curves correspond to several tests performed on different spots of the electrode.

FIG. 8 provides various data relating to the electrical properties of Si-NW/GNR papers. FIG. 8A shows the charge-discharge profile of Si-NW/GNR papers, utilized as a Li-ion battery, with the first two cycles presented at 0.2 A.g⁻¹. FIG. 8B shows cyclic voltammograms (CVs) of Si-NW/GNR papers at 0.1 mV s⁻¹. FIG. 8C shows the areal energy storage capacity control of Si-NW/GNR papers through mass density per area of electrode. FIG. 8D shows volumetric energy storage capacity stability through cycling (0.2 A.g⁻¹).

FIG. 9 shows cross-sectional SEM images of GNRs, Si-NW/GNR and Si-NW papers. Images were taken on papers after opening an assembled coin cell. FIG. 9A shows an SEM image of a pure GNR film with a mass density of 2.5 mg cm⁻². FIGS. 9B-E show Si-NW/GNR films with Si mass density per area (tap density) of 0.8 mg cm⁻², 1.5 mg cm⁻², 3 mg cm⁻² and 6 mg cm⁻², respectively. Yellow arrows in FIG. 9E show a thickness of 37 μm for the Si-NW/GNR film with a mass density of 6 mg cm⁻². FIG. 9F shows pure Si-NW film over a GNR paper substrate with a mass density of 6 mg cm⁻² . Yellow arrows in FIG. 9F show a thickness of 39 μm for the pure Si-NW film. Images in FIGS. 9E-F are comparable in terms of mass of pure Si (6 mg cm⁻²). However, the image in FIG. 9E has an additional 2.5 mg cm⁻² of pure GNR within the film, which does not contribute significantly to the volume, as both films show similar thicknesses (i.e., 37 μm and 39 μm).

FIG. 10 provides additional data relating to the electrical properties of Si-NW/GNR papers, utilized as a Li-ion battery, including charge-discharge profiles at different rates (FIG. 10A), cycling stability at different rates (FIG. 10B), and long-term cycling stability at 1 A g⁻¹ (FIG. 10C).

FIG. 11 provides data relating to the characterization of lithium cobalt oxide (LiCoO₂) nanowires (LCO-NWs). FIG. 11A shows comparative X-ray diffractograms of hydrothermally synthesized LCO-NW (upper panel) and LiCoO₂ (lower panel). The comparison demonstrates a match of peaks in the prepared sample. FIG. 11B provides SEM images of the LCO-NWs. The LCO-NWs display the expected nanowire aspect. However, each one of the nanowires is composed of several nanometer sized particles (<200 nm) that have merged to form one LCO-NW.

FIG. 12 provides data relating to the energy storage capacity per area of LCO-NW/GNR films. FIG. 12A shows galvanostatic charge-discharge curves of LCO-NWs (half-cell tests) using different mass per area of LCO-NWs (7, 25 and ˜40 mg cm⁻²) and the corresponding areal energy storage capacity (in mAh cm⁻²). FIG. 12B shows the results of a stability test for the 7 and 40 mg cm⁻² mass density of half-cell LCO-NWs in terms of specific capacity.

FIG. 13 provides data relating to the characterization of battery cells that contain Si-NW/GNRs and LCO-NW/GNRs. FIG. 13A shows the charge-discharge profile of Si-NW/GNR and LCO-NW/GNR half-cells. The inset shows a full battery powering a smartphone LCD screen. FIG. 13B shows the charge-discharge profile of the full battery containing Si-NW/GNR and LCO-NW/GNR (4.05 V to 2.9 V at 0.2 A.g⁻¹). FIG. 13C shows a self-discharge test for the full battery 120 hours after full charge to 4.05 V.

FIG. 14 shows the effect of self-discharge of a full battery containing Si-NW/GNRs and LCO-NW/GNRs on voltage, capacity and energy after different resting times.

FIG. 15 provides additional data relating to the characterization of a full battery containing Si-NW/GNRs and LCO-NW/GNRs. FIGS. 15A-B provide data relating to the cycling stability of the full battery. The rates are expressed in terms of specific capacity/coulombic efficiency and energy density/energy conversion. FIG. 15C provides a Ragone plot of the full battery. FIG. 15D provides data relating to energy density and specific capacity of the full battery in terms of time of charge and discharge. FIG. 15E provides stability of the full battery upon cycling at 2 A.g⁻⁻¹.

FIG. 16 provides charge-discharge curves of a full battery containing Si-NW/GNRs and LCO-NW/GNRs at different rates (specific capacity is related to the Si mass).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

The widespread use of portable electronic devices has increased the demand for high performance energy storage systems. Present and future applications such as hybrid and total electrical vehicles, electric tools and portable devices (e.g., smartphones) require energy storage systems (e.g., lithium ion batteries (LIBs)) with improved features. These features include higher capacity, higher power, lower net weight, and extended life cycles. Depending on the application, different combinations of the aforementioned features must be met.

Currently, the most widely used battery technology is based on an anode composed of graphite, which has a theoretical capacity of 372 mAh g⁻¹, and a cathode based on lithiated metal oxides, such as LiCoO₂, whose total capacity is generally below 150 mAh g⁻¹. These two materials compose a LIB with a high voltage operation of ˜3.7 V, and relatively high energy densities of 100 to 250 Wh kg⁻¹. However, batteries produced from such materials have a limited capacity of ˜100 mAh g⁻¹. Therefore, new anodes and cathodes with higher specific capacities have been sought.

However, despite years of research, the capacities of high voltage metal oxide cathodes remain below 200 mAh.g⁻¹, although a few examples have attained small increments of capacity or higher voltage operation (e.g., >4 V, vs Li⁺/Li). An exception is sulfur, which has a capacity of 1675 mAh g⁻¹, but a lower voltage of operation of 2.1 V.

On the other hand, several high capacity alternatives, such as Li metal, silicon (Si) and other alloying metals (e.g., Sn, Sb, and Al) are possible for use as anodes. Such higher capacities can decrease the total amount of anode mass necessary to compose the batteries, thereby increasing the energy density. In this sense, Si is particularly attractive due to its high capacity of ˜3800 mAh.g⁻¹ at room temperature, its earth abundance, environmentally friendliness, stability at ambient atmosphere and its voltage profile of ˜0.3 V. Hence, Si is compatible with the same high voltage operation of ˜3.7 V when combined with commercial cathodes.

The hurdles associated with Si anodes, such as its large volume expansion of up to 400%, low conductivity and high reactivity with common electrolytes, can compromise its stability and capacity. This has been previously addressed by employing capped Si nanostructures to prevent pulverization, using Si/C nanocomposites, limiting the extension of Li reaction with Si, and using specifically designed electrolytes to control the solid electrolyte interphase (SEI) formation.

The aforementioned strategies have generated anodes that deliver gravimetric energy storage capacities much higher than those seen in graphite. However, a higher gravimetric (or specific) energy storage capacity is by no means the most important factor to outperform graphite as an anode in LIBs.

For instance, it is desirable for a material with a higher specific capacity to be distributed over a small area because of the limited size of many electronic device components (e.g., LIB electrodes) Likewise, it is desirable for a material to display a competitive areal and volumetric energy storage capacity that at least meets current industry standards for graphite, which is 2 to 4 mAh cm⁻² and over 600 Wh L⁻¹.

Most Si anode half-cells have reported high specific capacities of 1000 to 3000 mAh g⁻¹. However, there is little to no information regarding the areal energy storage capacity of such anodes. As such, a need exists for electrically conductive materials that display compactness and improved electrical properties.

In some embodiments, the present disclosure pertains to scalable methods of making electrically conductive materials that include a network of interconnected nanowires and graphene nanoribbons. In some embodiments, the present disclosure pertains to the formed electrically conductive materials. In some embodiments, the electrically conductive materials of the present disclosure are utilized as components of various electronic devices (e.g., electrodes in batteries). In some embodiments, the present disclosure pertains to electronic devices (e.g., full batteries) that contain the electrically conductive materials of the present disclosure.

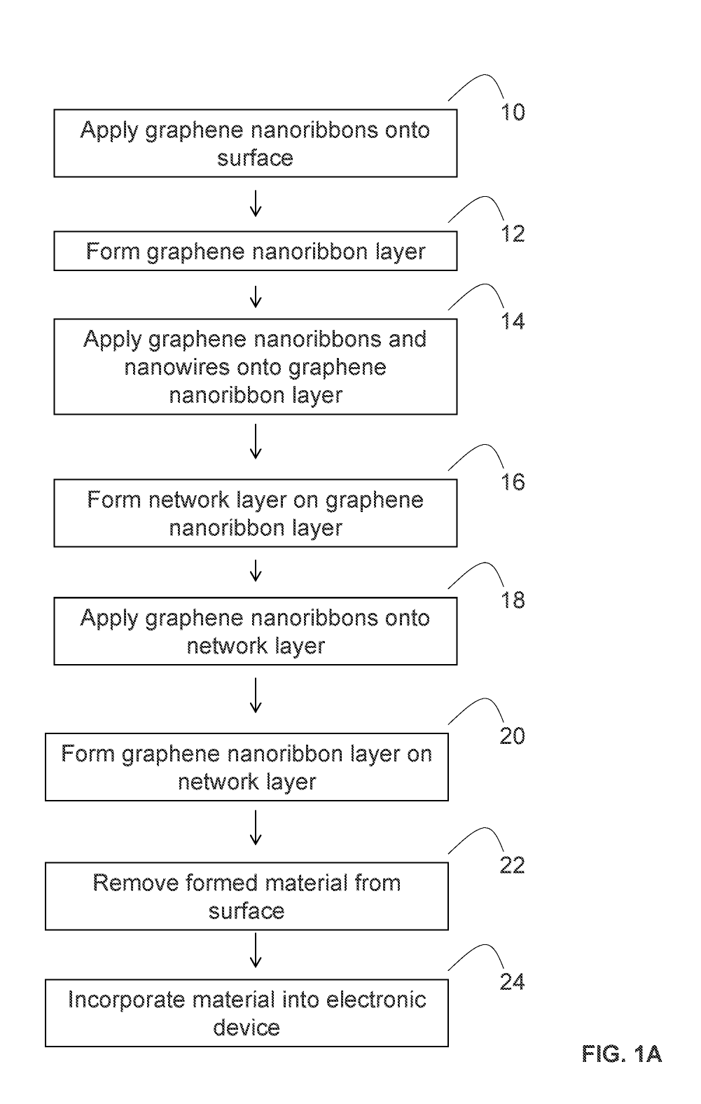

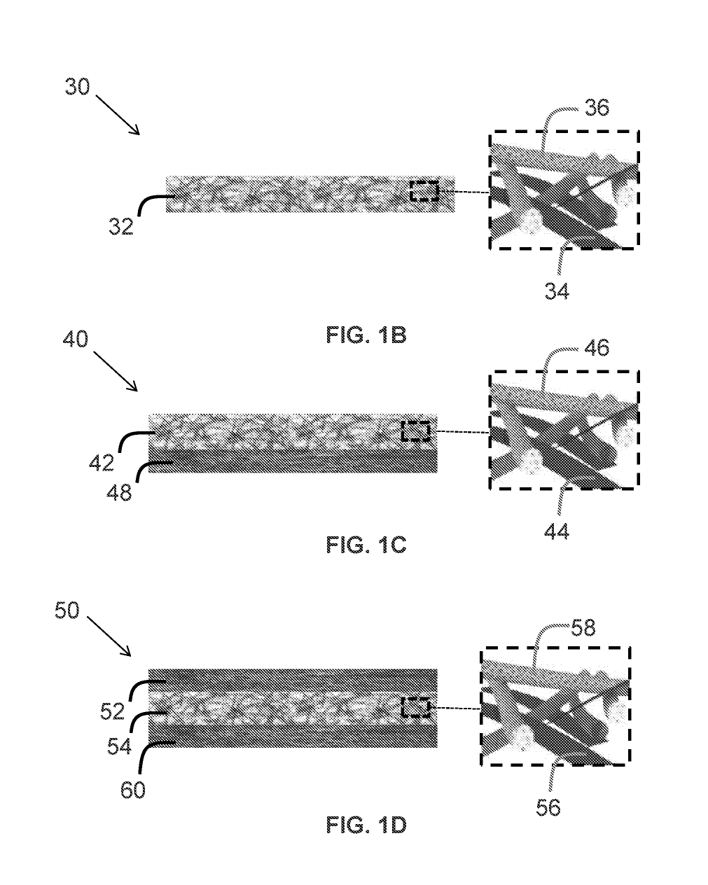

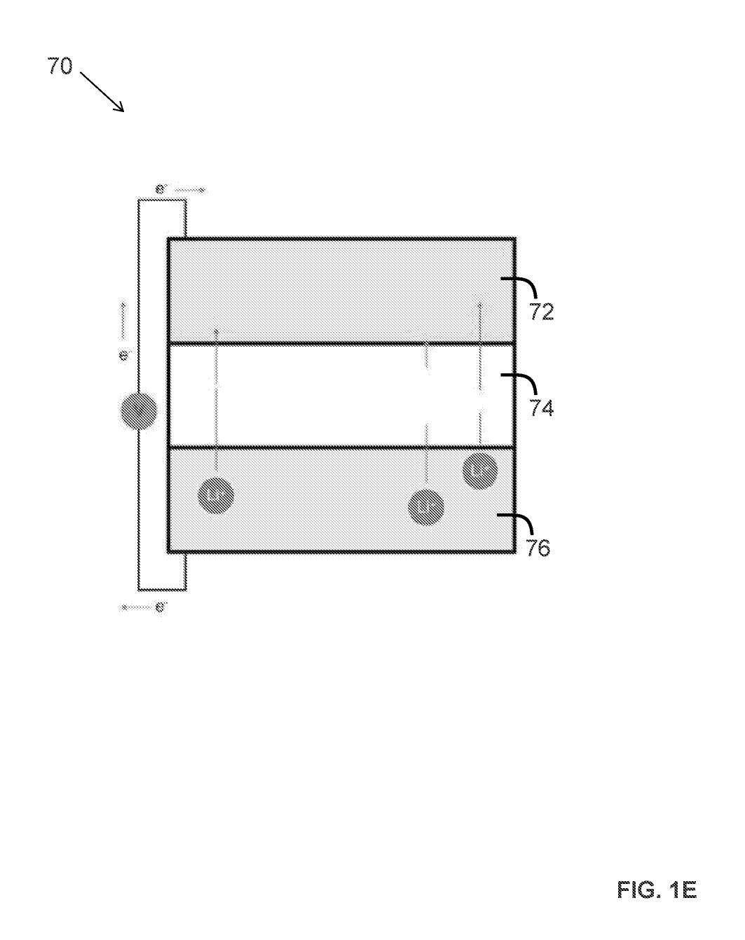

In more specific embodiments illustrated in FIG. 1A, the methods of the present disclosure involve one or more of the following steps: applying graphene nanoribbons onto a surface (step 10); forming a graphene nanoribbon layer on the surface (step 12); applying graphene nanoribbons and nanowires onto the formed graphene nanoribbon layer (step 14); forming a network layer on the graphene nanoribbon layer (step 16); applying graphene nanoribbons onto the network layer (step 18); forming a second graphene nanoribbon layer on the network layer (step 20); removing the formed material from the surface (step 22); and incorporating the formed material into an electronic device (step 24).

The methods of the present disclosure can be utilized to form various types of electrically conductive materials. Examples of such electrically conductive materials are illustrated in FIGS. 1B-D. For instance, FIG. 1B shows electrically conductive material 30 that includes network layer 32 with interconnected graphene nanoribbons 34 and nanowires 36.

Likewise, FIG. 1C shows electrically conductive material 40 that includes network layer 42 with interconnected graphene nanoribbons 44 and nanowires 46. Electrically conductive material 40 also contains graphene nanoribbon layer 48.

Similarly, FIG. 1D shows electrically conductive material 50 that includes network layer 54 with interconnected graphene nanoribbons 56 and nanowires 58. Electrically conductive material 50 also includes graphene nanoribbon layers 52 and 60 on opposite surfaces of network layer 54.

As set forth in more detail herein, the present disclosure can have various embodiments. For instance, various methods may be utilized to apply various types of graphene nanoribbons and nanowires onto various surfaces to form various types of electrically conductive materials with various types of network layers and graphene nanoribbon layers. Moreover, the electrically conductive materials of the present disclosure can be utilized as various components of various electronic devices.

Application of Graphene Nanoribbons and Nanowires onto Surfaces

The present disclosure can utilize various methods to apply graphene nanoribbons and nanowires onto surfaces. Moreover, the application steps can occur in various sequences.

For instance, in some embodiments, the applying step includes the application of a mixture of graphene nanoribbons and nanowires onto a surface to form a network layer that includes interconnected graphene nanoribbons and nanowires. In some embodiments, the application step also includes a first step of applying a dispersion of graphene nanoribbons onto the surface to form a graphene nanoribbon layer, and a second step of applying a mixture of nanowires and graphene nanoribbons onto the graphene nanoribbon layer to form the network layer. In some embodiments, the application step also includes a third step of applying a dispersion of graphene nanoribbons onto the formed network layer to form a second graphene nanoribbon layer on a surface of the network layer.

The application steps of the present disclosure can occur by various methods. In some embodiments, such methods can include, without limitation, filtration, ultrafiltration, coating, spin coating, spraying, spray coating, patterning, mixing, blending, thermal activation, electrochemical deposition, doctor-blade coating, screen printing, gravure printing, direct write printing, inkjet printing, and combinations thereof. In some embodiments, the applying occurs by filtration, such as vacuum filtration.

In some embodiments, the application steps occur while graphene nanoribbons and nanowires are dispersed in various solvents. In some embodiments, the solvents can include organic solvents. In some embodiments, the organic solvents can include, without limitation, N-methyl-2-pyrrolidone (NMP), acetone, chloroform, ortho-dichlorobenzene, dimethylformamide (DMF), dimethylsulfoxide (DMSO), toluene, xylene, and combinations thereof. In some embodiments, the solvent is NMP.

In some embodiments, the dispersion medium may be aqueous-based. In some embodiments, surfactants may be used in the dispersion medium to facilitate dispersion and stability. In some embodiments, the surfactants include, without limitation, sodium dodecyl sulfate, cetyl ammonium bromide, and combinations thereof.

In some embodiments, the dispersion medium may include rheology modifiers or stabilizers. In some embodiments, the rheology modifiers or stabilizers may include polymeric materials such as poly(acrylic acid), poly(vinylidene difluoride), polytetrafluoroethylene, carboxymethyl cellulose, and combinations thereof.

In some embodiments, the graphene nanoribbons and nanowires may be combined with a binder prior to application. In some embodiments, the binder may be a polymeric binder, such as poly(acrylic acid), poly(vinylidene difluoride), polytetrafluoroethylene, carboxymethyl cellulose, and combinations thereof. In some embodiments, a single multifunctional material (such as poly(acrylic acid) or carboxymethyl cellulose) may serve as the surfactant, rheology modifier, stabilizer, and binder. In some embodiments, a combination of different materials (such as the ones stated) may be used as the surfactant, rheology modifier, stabilizer, and binder.

Surfaces

The graphene nanoribbons and nanowires of the present disclosure can be applied onto various surfaces. For instance, in some embodiments, the surface is a porous membrane. In some embodiments, the porous membrane includes pore sizes that range from about 10 nm to about 10 μm. In some embodiments, the pore sizes in the porous membrane range from about 100 nm to about 500 nm.

In some embodiments, the surfaces of the present disclosure include polymer-based porous membranes. In some embodiments, the polymer-based porous membranes include, without limitation, polyethylene membranes, poly(vinyl) membranes, and combinations thereof. In some embodiments, the porous membranes include poly(vinylidene difluoride) (PVDF) or polyethylene membranes with pore sizes ranging from about 100 nm to about 450 nm.

Nanowires

The electrically conductive materials and methods of the present disclosure may utilize various nanowires. In some embodiments, the nanowires may include, without limitation, metal-based nanowires, metal oxide-based nanowires, chalcogenide-based nanowires, silicon-based nanowires (e.g., silicon alloy-based nanowires), lithium-based nanowires, sulfur-based nanowires, lithium cobalt oxide-based nanowires, nickel-based nanowires, tin-based nanowires, germanium-based nanowires, metal oxides, porous nanowires, carbon-based nanowires, carbon nanotubes, and combinations thereof.

In some embodiments, the nanowires of the present disclosure include silicon-based nanowires. In some embodiments, the silicon-based nanowires include silicon oxides. In some embodiments, the silicon oxides include SiO species, such as SiO₂ and SiO. In some embodiments, the silicon-based nanowires include porous silicon nanowires. In some embodiments, the silicon-based nanowires of the present disclosure include silicon alloy-based nanowires.

In some embodiments, the nanowires of the present disclosure include lithium-based nanowires. In some embodiments, the lithium-based nanowires include, without limitation, lithium oxides, lithium cobalt oxides, lithium nickel oxides, lithium iron oxides, lithium iron phosphates, lithium manganese oxides, lithium oxide alloys, and combinations thereof. In some embodiments, the lithium-based nanowires include, without limitation, LiCoO, LiCoO₂, LiNi_{1/3}Mn_{1/3}CO_{1/3}O₂, LiNi_{0.6}Mn_{0.2}CO_{0.2}O₂, LiNi_{0.5}Mn_{1.5}O₄, LiNiO₂, LiFePO₄, LiₓSi_{y} alloys, and combinations thereof.

In some embodiments, the nanowires of the present disclosure include carbon nanotubes. In some embodiments, the carbon nanotubes include, without limitation, single-walled carbon nanotubes, double-walled carbon nanotubes, triple-walled carbon nanotubes, multi-walled carbon nanotubes, and combinations thereof.

The nanowires of the present disclosure can include various widths. For instance, in some embodiments, the nanowires of the present disclosure include widths ranging from about 1 nm to about 1,000 nm. In some embodiments, the nanowires of the present disclosure include widths ranging from about 1 nm to about 500 nm. In some embodiments, the nanowires of the present disclosure include widths ranging from about 10 nm to about 300 nm. In some embodiments, the nanowires of the present disclosure include widths ranging from about 10 nm to about 250 nm. In some embodiments, the nanowires of the present disclosure include widths ranging from about 10 nm to about 100 nm.

The nanowires of the present disclosure can also include various lengths. For instance, in some embodiments, the nanowires of the present disclosure include lengths ranging from about 1 μm to about 100 μm. In some embodiments, the nanowires of the present disclosure include lengths ranging from about 10 μm to about 100 μm. In some embodiments, the nanowires of the present disclosure include lengths ranging from about 10 μm to about 50 μm. In some embodiments, the nanowires of the present disclosure include lengths of about 10 μm.

The nanowires of the present disclosure can also include various length to diameter (L/D) ratios. For instance, in some embodiments, the nanowires of the present disclosure include length to diameter ratios that range from about 1 to about 500. In some embodiments, the nanowires of the present disclosure include length to diameter ratios that range from about 10 to about 500. In some embodiments, the nanowires of the present disclosure include a length to diameter ratio of about 100.

The nanowires of the present disclosure can be fabricated by various methods. For instance, in some embodiments, the nanowires of the present disclosure can be fabricated by etching a substrate to form the nanowires from the substrate. The nanowires can then be separated from the substrate by various methods, such as sonication. In more specific embodiments, silicon-based nanowires (e.g., porous silicon nanowires) can be fabricated by chemical etching a silicon wafer (e.g., a boron doped silicon wafer) with solutions of hydrofluoric acid and silver nitrate (AgNO₃). Thereafter, the formed silicon-based nanowires can be removed from the silicon wafer by sonicating the wafers.

Graphene Nanoribbons

The electrically conductive materials and methods of the present disclosure may also utilize various graphene nanoribbons. For instance, in some embodiments, the graphene nanoribbons include, without limitation, functionalized graphene nanoribbons, pristine graphene nanoribbons, doped graphene nanoribbons, graphene oxide nanoribbons, reduced graphene oxide nanoribbons, reduced graphene oxide flakes, and combinations thereof.

In some embodiments, the graphene nanoribbons include functionalized graphene nanoribbons that are functionalized with a plurality of functional groups. In some embodiments, the functional groups include, without limitation, halogenated groups, fluorinated groups, hydrophobic groups, and combinations thereof. In some embodiments, the functional groups include fluorinated groups.

In some embodiments, the graphene nanoribbons are functionalized with alkyl groups. In some embodiments, the alkyl groups include, without limitation, halogenated alkyl groups, fluorinated alkyl groups, hydrophobic alkyl groups, and combinations thereof. In some embodiments, the alkyl groups include fluorinated alkyl groups. In some embodiments, the fluorinated alkyl groups include, without limitation, perfluorododecyl groups, perfluorooctyl groups, perfluorodecyl groups, and combinations thereof.

In some embodiments, the graphene nanoribbons are functionalized with hydrophobic alkyl groups. In some embodiments, the hydrophobic alkyl groups include, without limitation, saturated alkyl groups, such as hexadecyl groups. In some embodiments, the graphene nanoribbons include hexadecyl-functionalized graphene nanoribbons.

In some embodiments, the graphene nanoribbons are functionalized with hydrophobic functional groups. In some embodiments, the hydrophobic functional groups include hydrophobic polymers. In some embodiments, the hydrophobic polymers include, without limitation, polvinyls, poly(N-vinylpyrrolidone), polybutadiene, polystyrene, polyisoprene, poly(N-vinylformamide), and combinations thereof. In some embodiments, the graphene nanoribbons include poly(N-vinylformamide) functionalized graphene nanoribbons.

The graphene nanoribbons of the present disclosure can include various layers. For instance, in some embodiments, the graphene nanoribbons of the present disclosure include a single layer. In some embodiments, the graphene nanoribbons of the present disclosure include a plurality of layers. In some embodiments, the graphene nanoribbons of the present disclosure include from about 1 layer to about 60 layers. In some embodiments, the graphene nanoribbons of the present disclosure include from about 2 layers to about 10 layers. In some embodiments, the graphene nanoribbon layers have interlayer spacings of more than about 0.2 nm. In some embodiments, the graphene nanoribbon layers have interlayer spacings of 0.34 nm or larger.

The graphene nanoribbons of the present disclosure can have various widths. For instance, in some embodiments, the graphene nanoribbons of the present disclosure include widths ranging from about 75 nm to about 750 nm. In some embodiments, the graphene nanoribbons of the present disclosure include widths of less than about 500 nm. In some embodiments, the graphene nanoribbons of the present disclosure include widths of less than about 350 nm. In some embodiments, the graphene nanoribbons of the present disclosure include widths of less than about 250 nm. In some embodiments, the graphene nanoribbons of the present disclosure include widths of more than about 250 nm. In some embodiments, the graphene nanoribbons of the present disclosure include widths ranging from about 250 nm to about 350 nm. In some embodiments, the graphene nanoribbons of the present disclosure include widths ranging from about 250 nm to about 500 nm. In some embodiments, the graphene nanoribbons of the present disclosure include widths of about 350 nm. In some embodiments, the graphene nanoribbons of the present disclosure include widths of about 250 nm.

The graphene nanoribbons of the present disclosure can also have various lengths. For instance, in some embodiments, the graphene nanoribbons of the present disclosure include lengths ranging from about 1 μm to about 100 μm. In some embodiments, the graphene nanoribbons of the present disclosure include lengths ranging from about 10 μm to about 100 μm. In some embodiments, the graphene nanoribbons of the present disclosure include lengths ranging from about 10 μm to about 50 μm. In some embodiments, the graphene nanoribbons of the present disclosure include lengths ranging from about 30 μm to about 50 μm.

The graphene nanoribbons of the present disclosure can also have various length-to-width aspect ratios. For instance, in some embodiments, the graphene nanoribbons of the present disclosure include length-to-width aspect ratios that range from about 100 to about 150. In some embodiments, the graphene nanoribbons of the present disclosure include a length-to-width aspect ratio of about 140. In some embodiments, the graphene nanoribbons of the present disclosure include a length-to-width aspect ratio of more than about 140.

The graphene nanoribbons of the present disclosure may be derived from various carbon sources. For instance, in some embodiments, the graphene nanoribbons of the present disclosure may be derived from carbon nanotubes, such as multi-walled carbon nanotubes. In some embodiments, the graphene nanoribbons of the present disclosure are derived through the longitudinal splitting (or “unzipping”) of carbon nanotubes.

Various methods may be used to split (or “unzip”) carbon nanotubes to form graphene nanoribbons. In some embodiments, carbon nanotubes may be split by exposure to potassium, sodium, lithium, alloys thereof, metals thereof, salts thereof, and combinations thereof. For instance, in some embodiments, the splitting may occur by exposure of the carbon nanotubes to a mixture of sodium and potassium alloys, a mixture of potassium and naphthalene solutions, and combinations thereof.

In some embodiments, the graphene nanoribbons of the present disclosure are made by the longitudinal splitting of carbon nanotubes using oxidizing agents (e.g., KMnO₄). In some embodiments, the graphene nanoribbons of the present disclosure are made by the longitudinal opening of carbon nanotubes (e.g., multi-walled carbon nanotubes) through in situ intercalation of Na/K alloys into the carbon nanotubes. In some embodiments, the intercalation may be followed by quenching with a functionalizing agent (e.g., 1-iodohexadecane) to result in the production of functionalized graphene nanoribbons (e.g., hexadecyl-functionalized graphene nanoribbons).

Additional variations of such embodiments are described in U.S. Provisional Application No. 61/534,553 entitled “One Pot Synthesis of Functionalized Graphene Oxide and Polymer/Graphene Oxide Nanocomposites.” Also see PCT/U.S.2012/055414, entitled “Solvent-Based Methods For Production Of Graphene Nanoribbons.” Also see Higginbotham et al., “Low-Defect Graphene Oxide Oxides from Multiwalled Carbon Nanotubes”, ACS Nano 2010, 4, 2059-2069. Also see Applicants' co-pending U.S. patent application Ser. No. 12/544,057 entitled “Methods for Preparation of Graphene Oxides From Carbon Nanotubes and Compositions, Thin Composites and Devices Derived Therefrom.” Also see Kosynkin et al., “Highly Conductive Graphene Oxides by Longitudinal Splitting of Carbon Nanotubes Using Potassium Vapor”, ACS Nano 2011, 5, 968-974. Also see WO 2010/14786A1.

Network Layers

In the present disclosure, network layers generally refer to layers that include interconnected graphene nanoribbons and nanowires. The methods of the present disclosure can be utilized to form various types of network layers. Likewise, the electrically conductive materials of the present disclosure can include various network layers.

Graphene nanoribbons and nanowires can have various arrangements within network layers. For instance, in some embodiments, graphene nanoribbons and nanowires form an interpenetrated matrix within a network layer. In some embodiments, graphene nanoribbons and nanowires define an electrical pathway within a network layer. In some embodiments, the network layer includes a stable conductive path across the network layer. In some embodiments, the network layer includes multiple contact points between graphene nanoribbons and nanowires. In some embodiments, the network layer includes multiple electrical connections between the graphene nanoribbons and nanowires.

In some embodiments, graphene nanoribbons and nanowires are dispersed within the network layer. In some embodiments, graphene nanoribbons and nanowires are entangled within the network layer. In some embodiments, graphene nanoribbons and nanowires are dispersed and entangled within the network layer.

The network layers of the present disclosure can also have various structures. For instance, in some embodiments, the network layers of the present disclosure have a crystalline structure. In some embodiments, the network layers of the present disclosure have a single crystalline structure. In some embodiments, the network layers of the present disclosure include a plurality of crystalline domains. In some embodiments, the crystalline domains are distributed homogenously throughout the network layer. In some embodiments, the crystalline domains include diameters of less than about 10 nm.

The network layers of the present disclosure can include various amounts of graphene nanoribbons. For instance, in some embodiments, the graphene nanoribbons constitute from about 0.1 wt % to about 50 wt % of the network layer. In some embodiments, the graphene nanoribbons constitute from about 0.1 wt % to about 25 wt % of the network layer. In some embodiments, the graphene nanoribbons constitute from about 0.1 wt % to about 10 wt % of the network layer. In some embodiments, the graphene nanoribbons constitute about 20 wt % of the network layer.

The network layers of the present disclosure can also include various amounts of nanowires. For instance, in some embodiments, the nanowires constitute from about 40 wt % to about 90 wt % of the network layer. In some embodiments, the nanowires constitute about 80 wt % of the network layer.

The network layers of the present disclosure can include various thicknesses. For instance, in some embodiments, the network layers of the present disclosure include a thickness ranging from about 1 μm to about 500 μm. In some embodiments, the network layers of the present disclosure include a thickness ranging from about 10 μm to about 50 μm. In some embodiments, the network layers of the present disclosure include a thickness ranging from about 30 μm to about 40 μm.

Removal of electrically conductive materials from a surface

In some embodiments, the methods of the present disclosure also include a step of removing the formed electrically conductive material from a surface. Various methods may be utilized to remove an electrically conductive material from a surface. For instance, in some embodiments, the removal occurs by peeling the formed electrically conductive material from the surface. In some embodiments, the removal occurs by mechanical agitation. In some embodiments, the removal occurs by dissolving the surface in a solvent. Additional removal methods can also be envisioned.

Electrically Conductive Materials

The methods of the present disclosure can be utilized to form various types of electrically conductive materials. Additional embodiments of the present disclosure pertain to the formed electrically conductive materials.

The electrically conductive materials of the present disclosure can include various structures (e.g., structures described previously with reference to FIGS. 1C-D). For instance, in some embodiments, the electrically conductive materials of the present disclosure include a network layer (e.g., network layer 32 in FIG. 1B) with interconnected graphene nanoribbons and nanowires. As set forth previously, the electrically conductive materials of the present disclosure can include various types and amounts of graphene nanoribbons and nanowires (e.g., graphene nanoribbons with a single layer to multiple layers, such as multiple graphene nanoribbon layers with interlayer spacings of 0.34 nm or larger). In some embodiments, the electrically conductive materials of the present disclosure exclude additional materials, such as graphite, copper, or aluminum foil. In some embodiments, the electrically conductive materials of the present disclosure include the additional materials.

In some embodiments, the electrically conductive materials of the present disclosure also include a graphene nanoribbon layer associated with a network layer (e.g., graphene nanoribbon layer 48 associated with a surface of network layer 42, as shown in FIG. 1C). In some embodiments, the electrically conductive materials of the present disclosure include at least two graphene nanoribbon layers associated with a network layer (e.g., graphene nanoribbon layers 52 and 60 associated with opposite surfaces of network layer 54, as shown in FIG. 1D).

The electrically conductive materials of the present disclosure can be in various forms. For instance, in some embodiments, the electrically conductive materials of the present disclosure are in the form of structures that include, without limitation, films, sheets, papers, mats, and combinations thereof. In some embodiments, the electrically conductive materials of the present disclosure are in the form of a paper.

In some embodiments, the electrically conductive materials of the present disclosure are free-standing. In some embodiments the electrically conductive materials of the present disclosure have a three-dimensional structure. In some embodiments, the electrically conductive materials of the present disclosure include a polycrystalline lattice.

The electrically conductive materials of the present disclosure can also have various thicknesses. For instance, in some embodiments, the electrically conductive materials of the present disclosure have thicknesses ranging from about 1 μm to about 500 μm. In some embodiments, the electrically conductive materials of the present disclosure have thicknesses ranging from about 10 μm to about 200 μm. In some embodiments, the electrically conductive materials of the present disclosure have thicknesses ranging from about 30 μm to about 100 μm.

Electrical Properties

The electrically conductive materials of the present disclosure can also have various advantageous electrical properties. For instance, in some embodiments, the electrically conductive materials of the present disclosure have conductivities that range from about 250 nS m⁻¹ to about 3,000 nS m⁻¹. In some embodiments, the electrically conductive materials of the present disclosure have conductivities that range from about 500 nS m⁻¹ to about 1,500 nS m⁻¹. In some embodiments, the electrically conductive materials of the present disclosure have conductivities that range from about 1,000 nS m⁻¹ to about 1,500 nS m⁻¹. In some embodiments, the electrically conductive materials of the present disclosure have conductivities that range from about 1,200 nS m⁻¹ to about 1,300 nS m⁻¹.

The electrically conductive materials of the present disclosure can also have various gravimetric energy storage capacities. For instance, in some embodiments, the electrically conductive materials of the present disclosure can have gravimetric energy storage capacities of more than about 500 mAh g⁻¹. In some embodiments, the electrically conductive materials of the present disclosure have gravimetric energy storage capacities of more than about 500 mAh g⁻¹. In some embodiments, the electrically conductive materials of the present disclosure have gravimetric energy storage capacities that range from about 1,000 mAh g⁻¹ to about 10,000 mAh g⁻¹. In some embodiments, the electrically conductive materials of the present disclosure have gravimetric energy storage capacities that range from about 2,000 mAh g⁻¹ to about 3,000 mAh g⁻¹. In some embodiments, the electrically conductive materials of the present disclosure have gravimetric energy storage capacities that range from about 2,500 mAh g⁻¹ to about 3,000 mAh g⁻¹. In some embodiments, the electrically conductive materials of the present disclosure have gravimetric energy storage capacities that range from about 2,800 mAh g⁻¹ to about 3,000 mAh g⁻¹.

The electrically conductive materials of the present disclosure can also have various areal energy storage capacities. For instance, in some embodiments, the electrically conductive materials of the present disclosure have areal energy storage capacities ranging from about 1 mAh cm⁻² to about 10 mAh cm⁻². In some embodiments, the electrically conductive materials of the present disclosure have areal energy storage capacities ranging from about 5 mAh cm⁻² to about 10 mAh cm⁻². In some embodiments, the electrically conductive materials of the present disclosure have areal energy storage capacities of about 10 mAh cm ⁻² . In some embodiments, the electrically conductive materials of the present disclosure have areal energy storage capacities ranging from about 10 mAh cm² to about 11 mAh cm⁻².

The electrically conductive materials of the present disclosure can also have various volumetric energy storage capacities. For instance, in some embodiments, the electrically conductive materials of the present disclosure have volumetric energy storage capacities ranging from about 500 mAh cm ⁻³ to about 4,000 mAh cm ³. In some embodiments, the electrically conductive materials of the present disclosure have volumetric energy storage capacities ranging from about 3,000 mAh cm⁻³ to about 4,000 mAh cm⁻³. In some embodiments, the electrically conductive materials of the present disclosure have volumetric energy storage capacities ranging from about 3,500 mAh cm⁻³ to about 4,000 mAh cm⁻³. In some embodiments, the electrically conductive materials of the present disclosure have volumetric energy storage capacities ranging from about 3,900 mAh cm⁻³ to about 4,000 mAh cm⁻³.

Without being bound by theory, it is envisioned that many of the aforementioned electrical properties can be attributed to the combined presence of graphene nanoribbons and nanowires in the electrically conductive materials of the present disclosure. For instance, since graphene nanoribbons combine the features of carbon nanotubes (e.g., cylindrical, one-dimensional, long, and high length to diameter ratios) and graphenes (e.g., flat, two-dimensional, and high width to thickness ratios) into flat, one-dimensional, and long structures, the graphene nanoribbons provide improved interfacial contact with nanowires (e.g., porous Si nanowires). Such improved interfacial contact can in turn provide enhanced electrical properties, such as enhanced capacities. However, the combination of nanowires with other nanomaterials (e.g., carbon nanotubes, graphenes, graphites, and carbon black) do not provide such improved interfacial contacts .

Components of Electronic Devices

In some embodiments, the electrically conductive materials of the present disclosure may be utilized as components of various electronic devices. As such, in some embodiments, the methods of the present disclosure also include a step of incorporating the electrically conductive materials of the present disclosure as a component of an electronic device. In some embodiments, the present disclosure pertains to electronic devices that contain the electrically conductive materials of the present disclosure.

The electrically conductive materials of the present disclosure may be utilized as components of various electronic devices. For instance, in some embodiments, the electronic device is an energy storage device or an energy generation device. In some embodiments, the electronic device is an energy storage device. In some embodiments, the electronic device includes, without limitation, capacitors, lithium-ion capacitors, super capacitors, micro supercapacitors, pseudo capacitors, batteries, lithium-ion batteries, electrodes, conductive electrodes, sensors, photovoltaic devices, photovoltaic cells, electronic circuits, fuel cell devices, thermal management devices, biomedical devices, transistors, water splitting devices, current collectors, and combinations thereof.

In some embodiments, the electrically conductive materials of the present disclosure may be an integral part of an electronic device. However, in some embodiments, the electrically conductive materials of the present disclosure may not be the only part of the functionality of the electronic device (e.g., functionality of electrochemical, photovoltaic, or thermoelectric devices).

In some embodiments, the electrically conductive materials of the present disclosure may be utilized as electrodes that include, without limitation, cathodes, anodes, electrochemical double layer capacitance (EDLC) electrodes, and combinations thereof. In some embodiments, the electrically conductive materials of the present disclosure are utilized as anodes (e.g., electrically conductive materials that contain silicon-based nanowires in the network layer). In some embodiments, the electrically conductive materials of the present disclosure are utilized as cathodes (e.g., electrically conductive materials that contain lithium-based nanowires in the network layer). In some embodiments, the electrically conductive materials of the present disclosure are utilized as cathodes and anodes.

In some embodiments, a network layer of an electrically conductive material (e.g., network layer 32 in FIG. 1B) serves as the active layer of an electrode. In some embodiments, a network layer of an electrically conductive material (e.g., network layer 42 in FIG. 1C) serves as the active layer of an electrode while a graphene nanoribbon layer of the electrically conductive material (e.g., graphene nanoribbon layer 48 in FIG. 1C) serves as the current collector of the electrode.

In more specific embodiments, the electrically conductive materials of the present disclosure are utilized as electrodes in a battery. In some embodiments, the battery includes, without limitation, micro batteries, lithium-ion batteries, lithium-sulfur batteries, sodium-ion batteries, magnesium-ion batteries, aluminum-ion batteries, and combinations thereof. In some embodiments, the battery is a lithium ion battery.

In some embodiments, the electronic devices that contain the electrically conductive materials of the present disclosure may also contain electrolytes. In some embodiments, the electrolytes include, without limitation, LiPF₆, LiBOB, LiTFSI, LiFSI, solvents, and combinations thereof. In some embodiments, the electrolytes are in the form of a composite material. In some embodiments, the electrolytes include solvents such as ethylene carbonate, diethyl carbonate, dimethyl carbonate, ethyl methyl carbonate, 1,2-dimethoxyl methane, and combinations thereof.

In a more specific embodiment illustrated in FIG. 1E, the electrically conductive materials of the present disclosure can be utilized as components of battery 70, where electrically conductive material 76 serves as a cathode, and where electrically conductive material 72 serves as an anode. In this illustration, electrically conductive materials 72 and 76 are separated by electrolytes 74.

Electronic Device Properties

The electronic devices that contain the electrically conductive materials of the present disclosure can have various advantageous properties. For instance, in some embodiments, energy storage devices that contain the electrically conductive materials of the present disclosure have an energy density ranging from about 100 Wh.kg⁻¹ to about 1,000 Wh.kg⁻¹. In some embodiments, the energy storage devices of the present disclosure have an energy density ranging from about 100 Wh.kg⁻¹ to about 500 Wh.kg⁻¹. In some embodiments, the energy storage devices of the present disclosure have an energy density ranging from about 100 Wh.kg⁻¹ to about 300 Wh.kg⁻¹. In some embodiments, the energy storage devices of the present disclosure have an energy density ranging from about 100 Wh.kg⁻¹ to about 300 Wh.kg⁻¹. In some embodiments, the energy storage devices of the present disclosure have an energy density of more than about 400 Wh.kg⁻¹.

The energy storage devices of the present disclosure can also include various operation voltages. For instance, in some embodiments, the energy storage devices of the present disclosure have operation voltages of more than about 1 V. In some embodiments, the energy storage devices of the present disclosure have operation voltages that range from about 1 V to about 10 V. In some embodiments, the energy storage devices of the present disclosure have operation voltages that range from about 2.5 V to about 5 V. In some embodiments, the energy storage devices of the present disclosure have operation voltages that range from about 2.5 V to about 4 V. In some embodiments, the energy storage devices of the present disclosure have operation voltages that range from about 3 V to about 4 V.

In some embodiments, the energy storage devices of the present disclosure have operation voltages ranging from about 1 V to about 5 V in a single cell. In some embodiments, the energy storage devices of the present disclosure have operation voltages of more than 10 V in a pack.

The energy storage devices of the present disclosure can also include various conversion efficiencies. For instance, in some embodiments, the energy storage devices of the present disclosure have a conversion efficiency of more than about 75%. In some embodiments, the energy storage devices of the present disclosure have a conversion efficiency of about 90%.

Moreover, due to the high capacities of the electrically conductive material, the energy storage devices of the present disclosure provide faster charging times and longer discharging times. Further, due to the use of graphene nanoribbons in electrically conductive materials, the energy storage devices of the present disclosure are lighter than conventional energy storage devices. For instance, due to the use of graphene nanoribbons as current collectors in some embodiments, the electrodes in the energy storage devices of the present disclosure are lighter than conventional energy storage devices that may utilize copper or aluminum foil current collectors.

Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### EXAMPLE 1

### Silicon Nanowires and Lithium Cobalt Oxide Nanowires in Graphene Nanoribbon Papers for Full Lithium Ion Batteries

In this Example, Applicants describe the production and characterization of a scalable method to produce three-dimensional (3D) lithium ion battery (LIB) anodes that are in the form of free-standing papers of porous silicon nanowires (Si-NW) and graphene nanoribbons (GNRs). Using simple filtration methods, graphene nanoribbons can be entangled into a mat, thereby forming Si-NW papers. This produces anodes with high gravimetric energy storage capacity (up to 2500 mAh g⁻¹), high areal energy storage capacities (up to 11 mAh cm−²), and high volumetric energy storage capacities (up to 3960 mAh cm⁻³).

Furthermore, the formed Si-NW/GNR papers exhibit a stable life cycle, even after 300 cycles. Combined with LiCoO₂ nanowires, a full battery is presented with high energy density (386 Wh kg)⁻¹ and an average potential of 3.65 V, thereby meeting the requirements for high performance devices (e.g., commercial graphite-based LIBs).

The compact structure of the anode is possible because the GNR volume occupies the high proportion of empty spaces within the composite paper. As such, the conductive and compact structure of the electrodes can be supported by GNRs alone as the current collector. The remainder of the structure is composed of a mixture of GNRs for improving conductivity, and Si-NWs for Li storage.

The produced materials provide an open structure accessible to the electrolyte. The produced materials also provide multiple electrical connections between GNRs and Si-NWs, two high aspect ratio materials that are resilient during continuous cyclings.

### Example 1.1

### Production of Si-NWs

Highly doped Si wafers (boron doped, resistivity <0.05 Ω.cm) were used to generate a Si-NW forest. The Si surface was cleaned using a bath sonicator (Cole Parmer Ultrasonic Cleaner, 12W, 55 kHz) in a soap solution (Contrex EZ, 1% mass in water) and then in isopropanol (10 minutes each). The surface was then dried using an air jet.

The cleaned wafers were dipped into a 10% v/v HF solution in water for 3 minutes and then directly dipped into the etching solution for 3 hours. The etching solution was composed of 0.03 mol L⁻¹ of AgNO₃ and 4.6 mol L⁻¹ of HF (as adapted from the literature (Nano Lett. 2009, 9, 3550; and Nanotech. 2011, 22, 155606). A total volume of 300 mL was used for etching an area of approximately 20 cm². At the end of this period, the Si wafer had an Ag deposit, which was removed by scraping it with a spatula.

Next, the silicon wafers were dipped in 1:1 water/HNO₃ (total volume 100 mL, 65%) for 2-3 minutes to remove the dendritic silver deposit. The wafers were then flushed abundantly with distilled water. At this point, the surface of the wafer was brownish black. The removal of Si-NW was done by sonicating the wafers in isopropanol (˜100 mL) using the same sonicator that was used for cleaning.

The orange dispersion was filtered (PTFE, 0.45 μm) and vacuum dried to obtain a solid powder. After the Si-NW removal, the wafers were recycled by dipping into an aqueous solution of KOH (0.3 mol L⁻¹) for 3 hours. Next, the wafers were washed abundantly with water and submitted to the same process.

### Example 1.2

### Production of Si-NW/GNR papers

A dispersion of 0.1 mg mL⁻¹ of GNRs (EMD Merck, hydrogen-terminated edges) and 2 mg mL⁻¹ of Si-NWs in N-methyl-2-pyrrolidone (NMP) was prepared by sonication. The GNR dispersion was obtained using a tip sonicator (Mis Onix Sonicator 3000, tip radius 6.5 mm, 500W, 20 kHz). The Si-NW dispersion was obtained using a low power bath sonicator (Cole Parmer Ultrasonic Cleaner, 12W, 55 kHz). A volume of 15 mL of the GNR dispersion was filtered (vacuum filtration on a 2 cm², 0.45 μm PTFE membrane filter) to prepare the bottom, pure GNR current collector. Then, a 1:2.5 (vol:vol) ratio of Si-NW and GNR dispersion were mixed and filtered over the GNR bottom layer, in order to prepare the top active layer of the electrode with 70-80 wt % of Si. The film was washed with methanol and ethanol to remove NMP residues and then the film was vacuum dried (<100 Torr) at room temperature.

After the drying process, the film was peeled from the PTFE membrane. A volume of 50 μL of a 40 mg mL⁻¹ solution of poly(acrylic acid) (Sigma Aldrich, 35 wt % in water, M_{w} 100000) in methanol was added by dropping over the free-standing film, which was then dried at room temperature. The film was further dried at 110° C. in vacuum (<100 Torr) for 6 hours and directly transferred to a glove box.

### Example 1.3

### LiCoO₂ Nanowire Synthesis

A mass of 1.87 g of CoCl₂.6H₂O and 0.48 g of urea (CO(NH₂)₂) were dissolved in 80 mL of distilled water. The solution was poured inside a Teflon lined hydrothermal reactor (steel autoclave) and the reaction was performed at 110° C. for 12 hours. The resulting pink precipitate was filtrated (0.45 μm PTFE membrane filter) and washed abundantly with water and then dried in an oven at 100° C. for 1 hour. The powder was then annealed in air at 500 ° C. for 5 hours for conversion to Co₃O₄ (black powder). The Co₃O₄ powder (0.58 g) was then mixed with LiOH (191.5 g) in a Co₃O₄:LiOH molar proportion of 1:3.3 in methanol (100 mL). The solution was then stirred for 3 hours at room temperature. Thereafter, the solvent was evaporated.

Next, the formed powder was submitted to a second annealing process in air by first heating to 450° C. for 3 hours and then to 750° C. for another 3 hours. This was followed by cooling to room temperature.

### Example 1.4

### Production of LiCoO₂-NW/GNR Papers

LiCoO₂-NW/GNR papers were prepared by the same method used for preparing Si anodes. A mass ratio of 1:5 of GNR to LiCoO₂ was used, according to the thickness of the film. The film was peeled from the PTFE membrane and a volume of a solution of PVDF in NMP (10 mg mL⁻¹) was added to the film such that the PVDF composed 5% in mass of the total electrode film. Finally, the film was dried at 70° C. under vacuum for 12 hours before use.

### Example 1.5

### Assembly of Half-Cell and Full Cell Batteries

The electrochemical tests were performed in a 2032 coin-type battery using Si-NW/GNR papers as the anode material and lithium foil as the counter and reference electrode. The area of the substrates was 0.5 to 1 cm². The electrolyte was composed of 1 mol L⁻¹ of LiPF₆ in ethylene carbonate:diethylene carbonate (EC:DEC) 1:1 and 5 wt % of fluorethylene carbonate (FEC)+1 wt % lithium bis(oxalate)borate (LiBOB).

The battery assembly was conducted inside a glove box with oxygen levels below 1 ppm. The separator was a Celgard membrane 2500. For sealing the coin cell, a pressure of 1000 psi was applied. For full batteries, a combined LiCoO₂-NW/GNR cathode with a 1:12 mass ratio of Si:LiCoO₂ was used. Both the cathode and anode had approximately the same geometric area (0.5 to 1 cm²)

### Example 1.6

### Morphology Measurements

Morphology and thickness measurements were performed using a scanning electron microscope (SEM, FEI, Quanta-FESEM 400) operated at 20 kV and a high-resolution transmission electron microscope (TEM, JEOL JEM-2100F) operated at 200 kV. Raman spectra were acquired using a 514.5 nm excitation line with a Renishaw Raman microscope. The X-ray diffractograms were obtained using Rigaku D/Max Ultima II (Cu Kα radiation, 1,5418 Å). Current-potential curves were measured at ambient conditions with a 4155C Agilent semiconductor parameter analyzer.

### Example 1.7

### Experimental Results

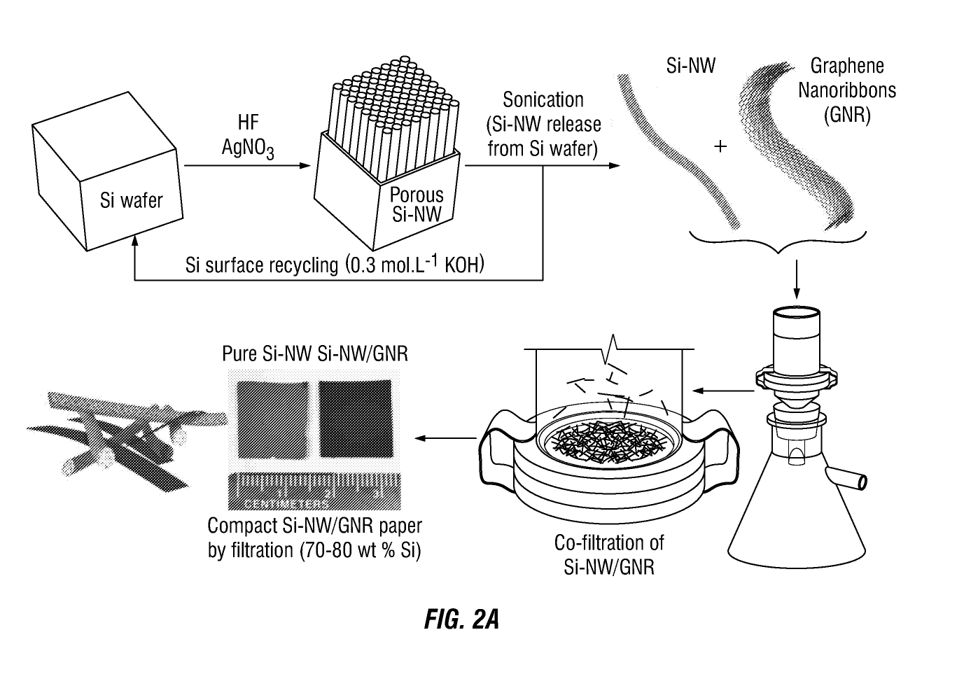

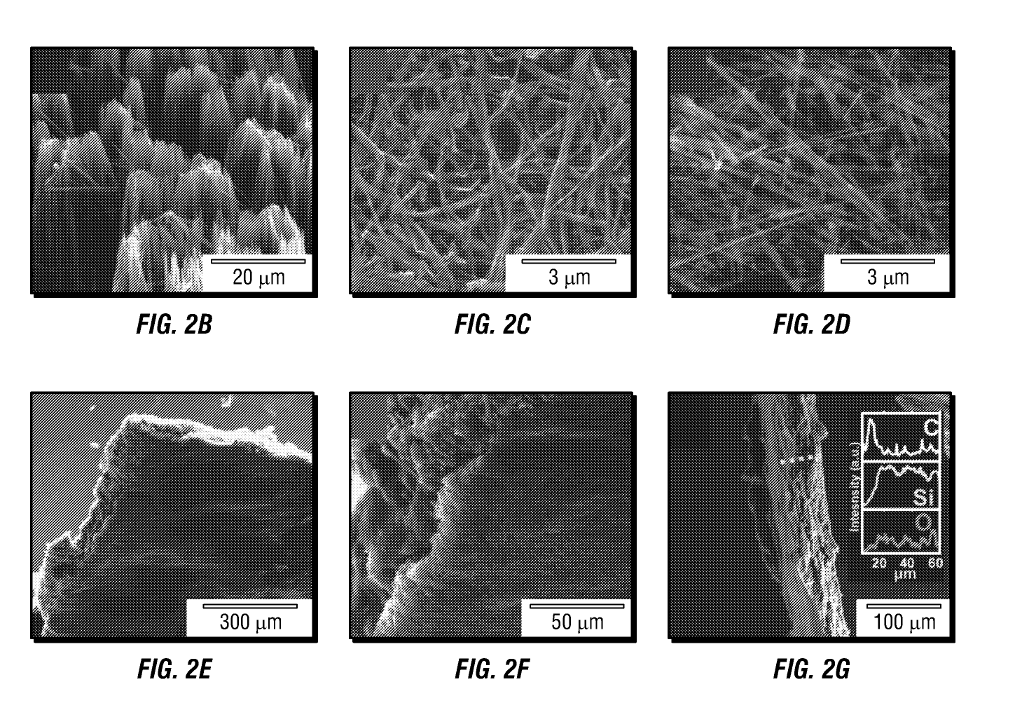

FIG. 2A displays the complete scheme for preparing compact free-standing paper made by porous silicon nanowires (Si-NW) and graphene nanoribbons (GNR). The porous silicon nanowires were produced by chemical etching from highly boron doped Si wafers in a one-step preparation scheme (Chem. Commun. 2013, 49, 7295). The metal assisted chemical etching method is known to be a versatile method to produce porous silicon nanowires from different Si sources, such as Si wafers (with different degrees of p or n-doping) or from pre-activated bulk Si particles. The produced Si nanowires were removed from the surface of wafers by employing a low power sonicator, thereby generating isolated Si-NWs that have a broad distribution of diameter (e.g., 10-100 nm) and average lengths of 10 μm. The porous structures are the result of the high doping level, which enables more active sites for the etching solution.

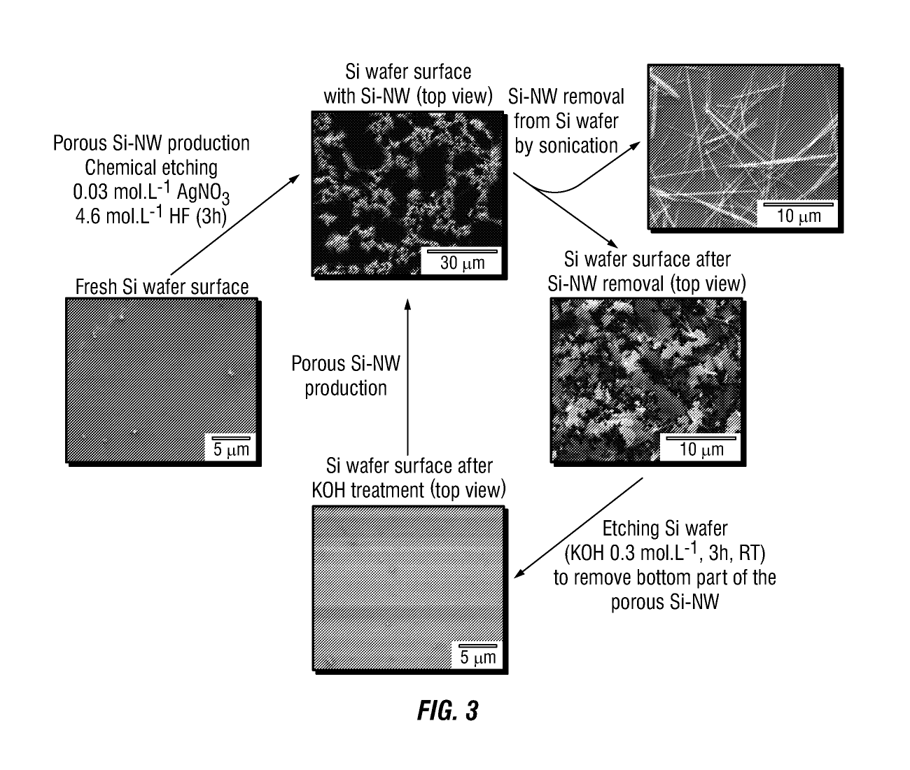

After the removal of Si-NWs, the wafer was recycled to prepare more Si-NWs. This was done by etching the root part of the wires that could not be removed by sonication by using a KOH solution (0.3 mol L⁻¹) and then following the same process to generate Si-NWs. The scanning electron microscopy (SEM) images of all materials after each step are presented in FIG. 3. The top-view SEM image of the vertically aligned forest of Si-NWs are displayed in FIG. 2B.

The isolated Si-NWs are then mixed with GNRs in solution and co-filtrated to compose the active layer of the electrode (FIG. 2A), in which the Si represents 70 to 80% of the mass of the electrode. The GNR preparation was previously described (ACS Nano 2012, 6, 4231), and is based on reductive splitting of multi-walled carbon nanotubes using a liquid Na/K alloy (FIG. 2C). The material used here was prepared using an analogous method by EMD-Merck.

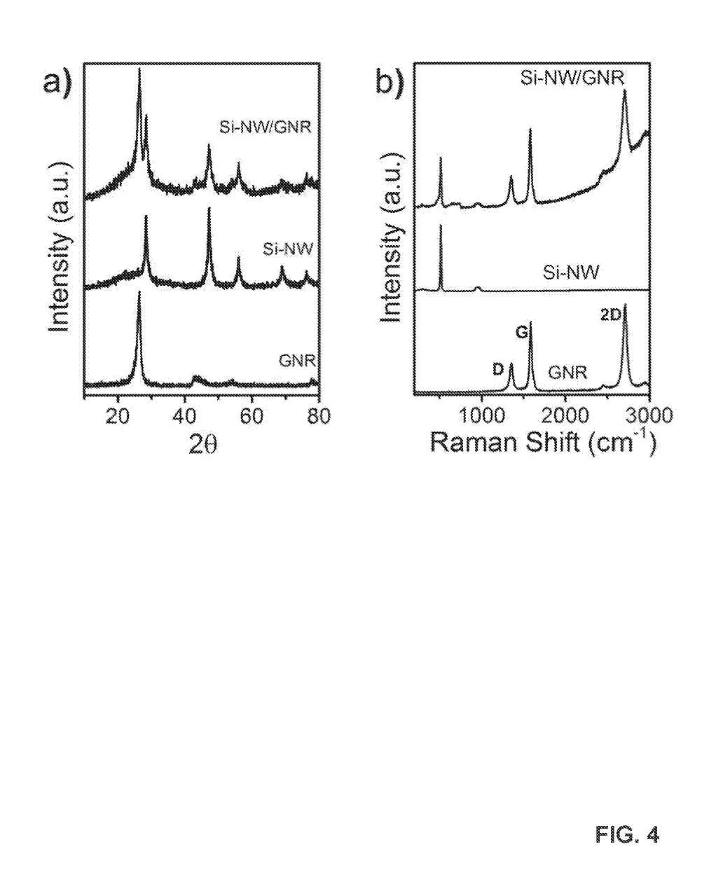

Raman spectra and X-ray diffractograms (XRD) of the materials and the Si-NW/GNR films are presented in FIG. 4. Evidence of the cubic (diamond-like) crystalline structure of the Si and the sp² signature of graphene samples are seen.

Photographs of the resulting free-standing papers are presented in FIG. 2A, in which a darker color is observed in the mixture of GNRs and Si-NWs. Si-NWs alone have a yellow color. The GNRs also improve the mechanical properties of the Si-NW films, making the nanocomposite paper more robust and flexible when compared to brittle pure Si-NW papers. The high aspect ratio of both materials is a helpful feature of this composition since it allows the Si-NWs and GNRs to have multiple contact points, thereby forming a stable conductive path across the electrode. Moreover, the GNRs can percolate through the empty spaces between the Si-NWs without contributing significantly to the volume of the electrode.

An SEM image (top view) of the compact Si-NW/GNR anode is shown in FIG. 2D. The image shows the entangled structure of Si-NWs and GNRs that work as a mat-like paper electrode. A pure GNR dispersion can also be filtered first to form a bottom layer electrode made of a thin pure GNR film that can work as a current collector, thereby avoiding the use of metals, such as Cu foil. The use of GNRs as the current collector also lowers the total mass of the anode.

FIGS. 2E-F show the bottom part of the Si-NW/GNR films composed solely of GNRs. The high concentration of GNRs at the bottom and the homogeneity of GNRs across the extension of the electrode was checked by imaging the cross-section of the Si-NW/GNR film (FIG. 2G). In addition, the Si, O and C signals were analyzed by energy dispersive X-ray spectroscopy (EDAX) (inset of FIG. 2G).

The line scan analysis, corresponding to the dotted line in FIG. 2G, confirms the homogeneity of Si and 0 from the native surface SiOₓ species. As expected, the C signal is more intense only at the bottom of the electrode.

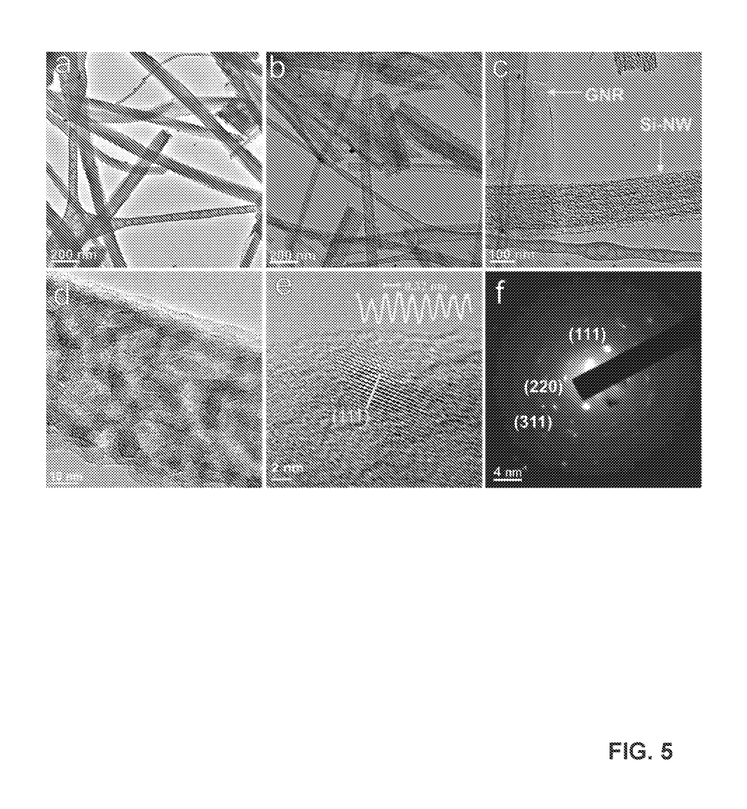

The porous nature of the Si-NWs generates empty spaces within the crystalline structure of the Si-NWs, which can help lower the stress caused by the high volume expansion during Li uptake. Transmission electron microscopy (TEM) of the Si-NWs, GNRs and mixtures of Si-NWs and GNRs are presented in FIG. 5. The porous Si-NW images (FIGS. 5B-E) shows that a variety of sizes and even bundles of Si-NWs can be found. In addition, the porous nature is seen by the contrast of the nanowires (FIG. 5B) .

Despite the different diameters of the Si-NWs, small (<10 nm) crystalline domains are observed to be distributed homogenously throughout the entire volume of the nanowires (FIG. 5D). These crystallite sizes are well below the critical level of 150 nm, the minimal estimated size to avoid intense fracture on the surface of the particles (pulverization process) during de-lithiation reaction.

A high resolution TEM image (FIG. 5E) identifies the diamond-like structure of the Si-NWs as the corresponding (111) atomic planes (0.32 nm) (inset of FIG. 5E, contrast profile of the atomic planes (111)). Evidence of the SiOₓ layer on the surface of the wires is also observed in FIGS. 5D-E. Selected area electron diffraction (SAED) (FIG. 5F) shows that the nanowires are single-crystalline.

The mixture of Si-NWs and GNRs was also inspected (FIG. 5C) and compared to images of pure GNRs in FIG. 5A. The mixture shows that several contact points of entangled Si-NWs and GNRs were obtained, with the flat structure of the GNRs touching several Si-NWs as expected for two materials with high aspect ratio. This prevents the use of isolated Si-NWs as bundles inside the electrode, which would increase the overall resistance of the anode.

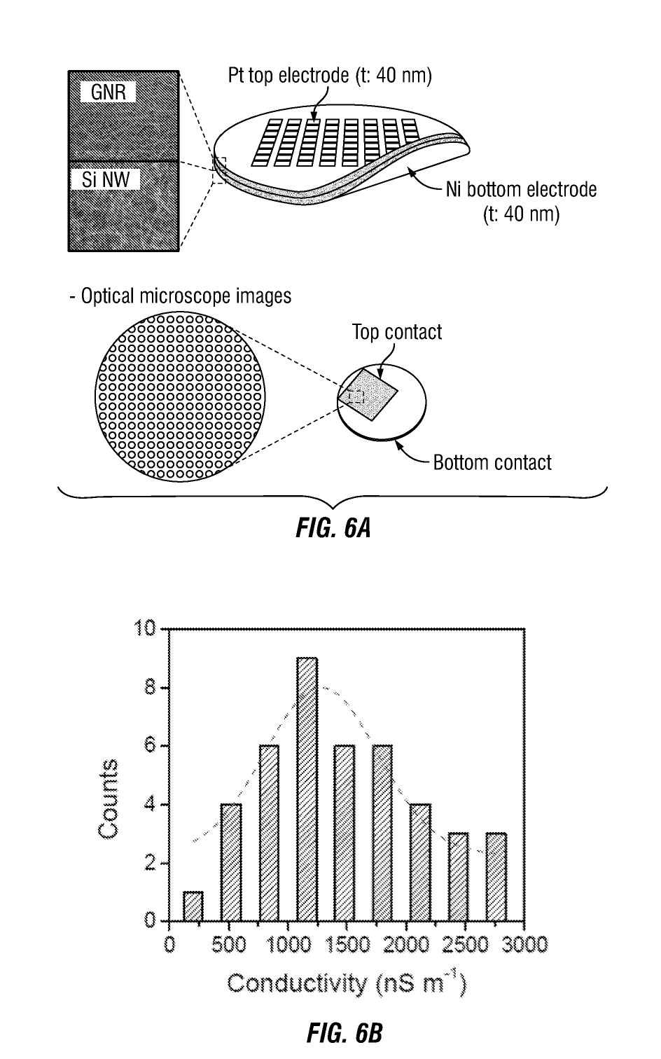

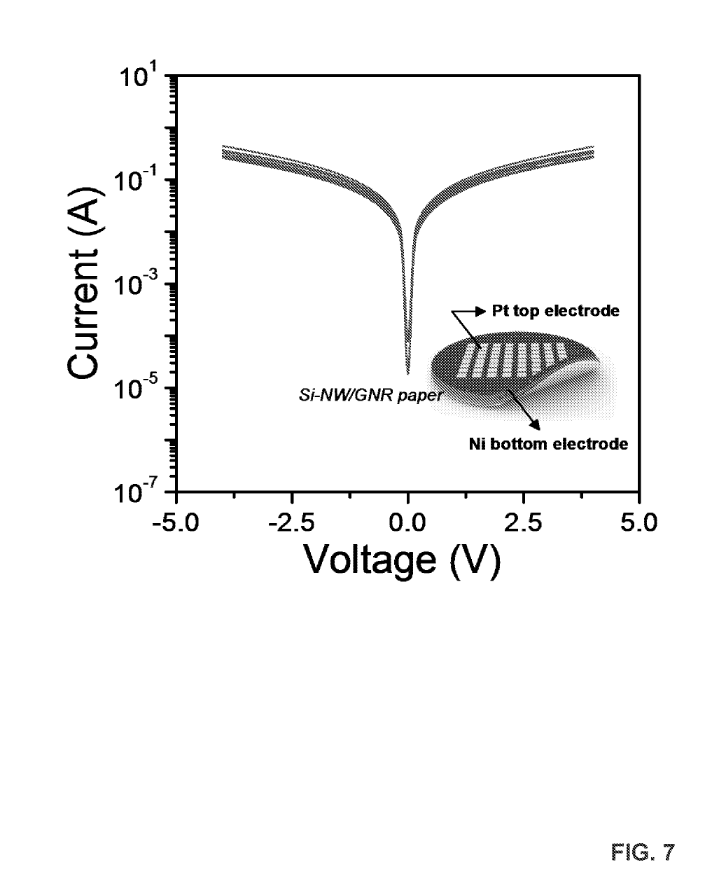

As in the case of random nanowire networks, higher aspect ratio materials enable more contact points, thereby minimizing the overall resistance of the paper. Current-potential measurements tested across the electrode shows good conductivity throughout the extension of the electrode, as tested over several points, giving an average conductivity of 1280 nS.m⁻¹ and a maximum conductivity of 2716 nS.m⁻¹ (FIGS. 6-7). This conductivity is comparable to carbon-coated silicon structures produced by polymer decomposition using high temperature methods.

### Example 1.8

### Electrochemical Characterization

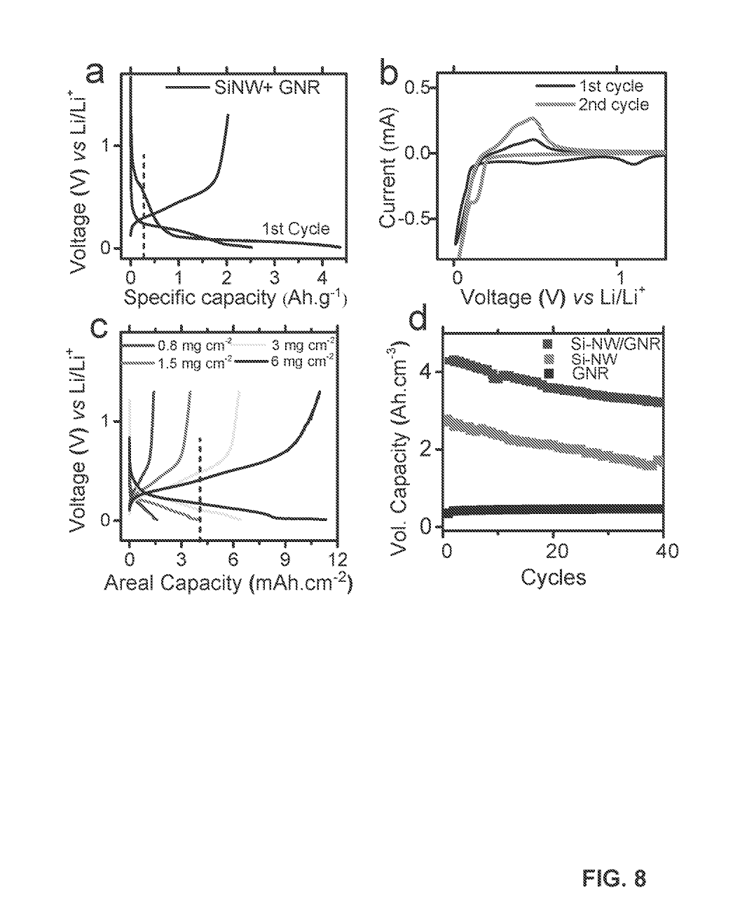

The conductivity data on the entangled structure of Si-NW/GNR papers show that the conductivity is constant, regardless of thickness. Galvanostatic charge-discharge curves of the anode are shown in FIG. 8 for determining the total capacity for lithiation in terms of mass, area and volume of the electrode in the range of 0.01 to 1.3 V. The first cycle of discharge (FIG. 8A) (lithiation reaction, formation of LiₓSi_{y} alloy) displays a large irreversible capacity when tested at 0.2 A g⁻¹ (as is known for Si anodes). The subsequent cycles shows reversible capacity of 2,000 to 2,500 mAh.g⁻¹, highly superior to the specific capacity of graphite (indicated as dashed line in FIG. 8A).

The alloying reaction in the first cycle follows the expected process at 0.1 V, which is expected for lithiation of crystalline Si. After the first process of lithiation, the formation of LiₓSi_{y} starts below 0.3 V, which is typical of amorphous Si. Both processes can be clearly observed in the cyclic voltammograms (CVs) (FIG. 8B), as well as the de-lithiation reactions. Si-NW/GNR anodes with different Si loadings per area of electrode were also tested, resulting in different areal energy storage capacities from ˜1.5 to 11 mAh cm⁻², comparatively higher than commercial requirements of 2 to 4 mAh cm⁻² (dashed line in FIG. 8C positioned at 4 mAh cm⁻²).

Despite the high capacity accumulated per area of electrode, the voltage profile (polarization between charge and discharge) does not change significantly with the increment of Si-NW per area. Despite the difference of thickness in these electrodes, the compact but open structure provided by the entangled Si-NW/GNR electrode permits homogenous access of the electrolyte to the surface of the Si-NWs. The highly compact structure of the anodes also leads to a high volumetric energy storage capacity of ˜3980 mAh cm⁻³ (FIG. 8D), one of the highest present in the literature and close to the theoretical volumetric energy storage capacity expected for packed Si particles.

Recently, Peled et al. reported a high areal energy storage capacity Si anode using Si-NWs grown inside carbon fiber paper (Nano Lett. 2015, 15, 3907). Although high capacity per area was achieved (up to 22 mAh cm⁻²), the Si-NWs were located within the volume of the carbon fiber. Therefore, the volumetric energy storage capacity was below 700 mAh cm⁻³. However, in this Example, Applicants were able to keep the same areal energy storage capacity and still attain considerably higher volumetric energy storage capacity.

The pure Si-NW paper performance has lower volumetric energy storage capacitance due its lower conductivity, while the pure GNR anode yields a volumetric energy storage capacity of 450 mAh cm⁻³, comparable to values found in graphite anodes (550 mAh cm⁻³).

As such, it is envisioned that GNRs are also active in the lithiation reaction. However, the contribution of GNRs to the total capacity of the Si-NWs is minimal and less than 5% in terms of total capacity. This was calculated by applying the same current density of a Si-NW/GNR half-cell to a half-cell battery containing only GNRs. While the applied current density is equivalent to 0.2 A g⁻¹ to the Si mass, it is equivalent to 0.8 A.g⁻¹ for pure GNR, leading to a lower capacity and therefore lower contribution for the Si-NW/GNR film capacity.

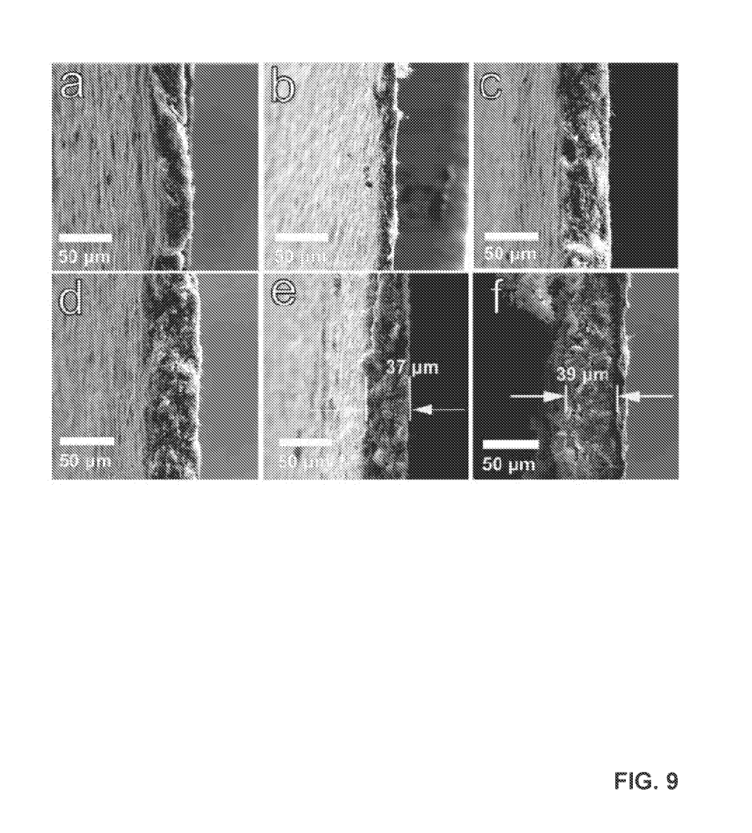

Without being bound by theory, it is envisioned that the high volumetric energy storage capacity can be justified by the lower volume contribution of GNRs throughout the Si-NW/GNR compact paper electrode. The cross-sectional image of the GNR films, Si-NW films and different mass loadings of Si-NW/GNR are shown in FIG. 9 (images taken after the coin cell assembly). Si-NW papers with and without GNRs present similar thicknesses of ˜40 μm (FIG. 9).

A large void space was apparent among the randomly packed Si-NWs. In fact, mathematical models show that low volume fractions (total volume occupied by the constituent particles) of less than 30% are found in materials with high aspect ratio, where the length to diameter ratio (L/D) is more than 30.

The estimated L/D of the Si-NWs is around ˜100. For GNRs, the estimated L/D is around ˜10. Therefore, it is envisioned that the empty space is occupied by the GNRs, percolating and generating a stable and conductive interpenetrated matrix inside the Si-NW packing. Moreover, it is envisioned that GNRs should remain stable during lithiation/delithiation reactions.

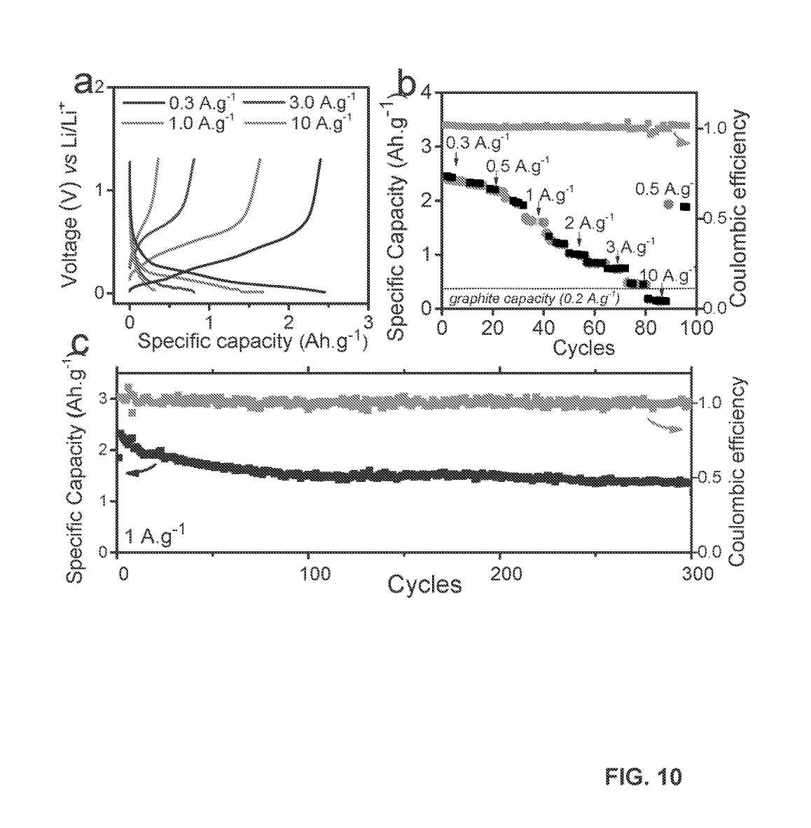

Applicants also tested the rate performance of Si-NW/GNR anodes and the cycling rate performance of the electrodes from 0.3 A g⁻¹ to 10 A g⁻¹. Applicants observed high capacities at high rate with little effect on the polarization up to 1 A g⁻¹. At higher rates, the measured polarization was high (0.5 to 0.7 V) (FIG. 10A). However, the capacity tested at these higher rates (i.e., up to 5 A g⁻¹) still outperformed the values found in graphite at lower rates (<0.1 A g⁻¹) (FIG. 10B).

The capacity response at different rates is dependent on the Li diffusion along the thickness direction, which in turn depends on the conductivity, SEI composition and crystalline structure of the material. After testing under high rate, the capacity can be recovered if tested again under lower rates (0.5 A g⁻¹) (FIG. 10B). The long-range stability is also demonstrated at 1 A g⁻¹ (FIG. 10C). Despite a loss at the first cycles in this test, a high capacity was observed (˜1500 mAh g⁻¹) with a coulombic efficiency above 99.6%.

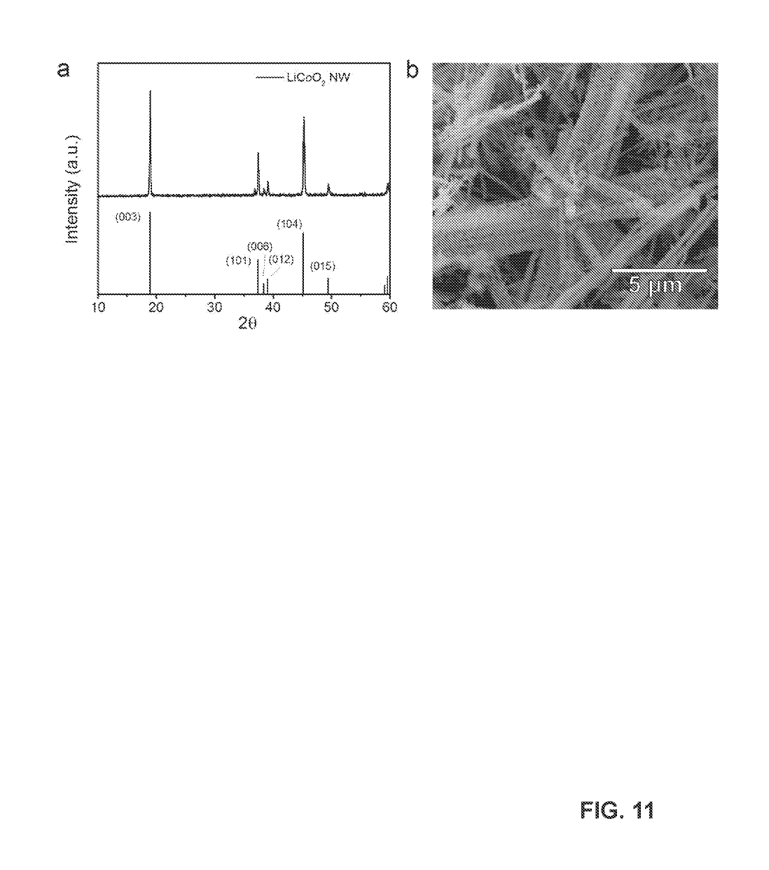

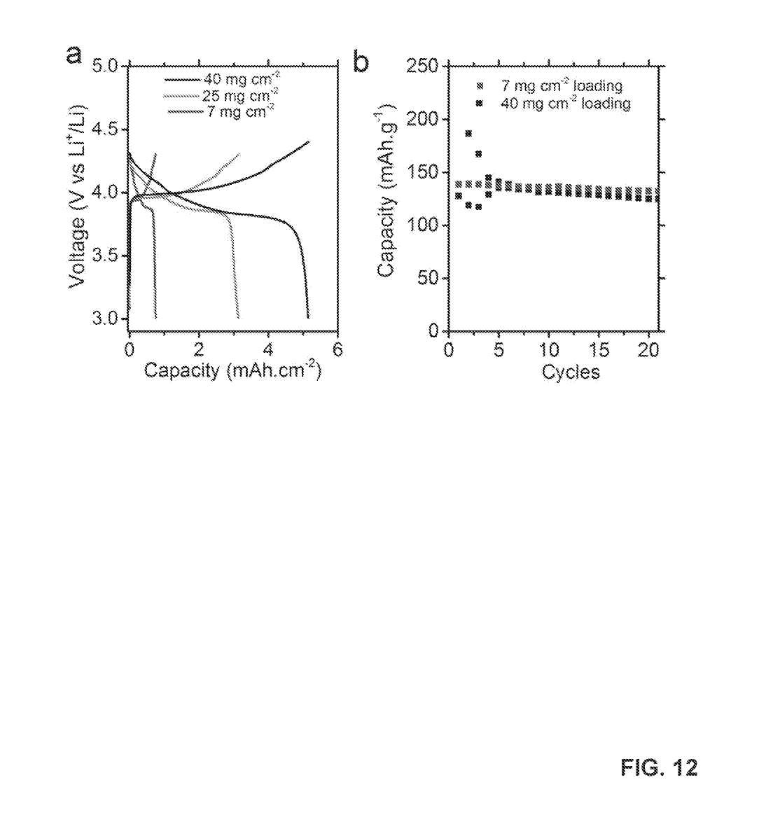

In order to compose a full cell, Applicants also performed studies using LiCoO₂ nanowires (LCO-NWs) synthesized by using an adapted hydrothermal method (Nano Res. 2011, 5, 27). The LCO-NWs were combined with GNRs to produce LCO-NW/GNR papers by filtration. The LCO-NWs with their characterization is shown in FIG. 11. The half-cell tests with the galvonastic charge-discharge curves are shown in FIG. 12.

High areal energy storage capacities can also be achieved per electrode for LCO-NW/GNRs (i.e., up to 5 mAh cm⁻²). The specific capacities at 0.14 A g⁻¹ for LCO-NWs was ˜150 mAh g⁻¹, close to the best values of LiCoO₂ reported.

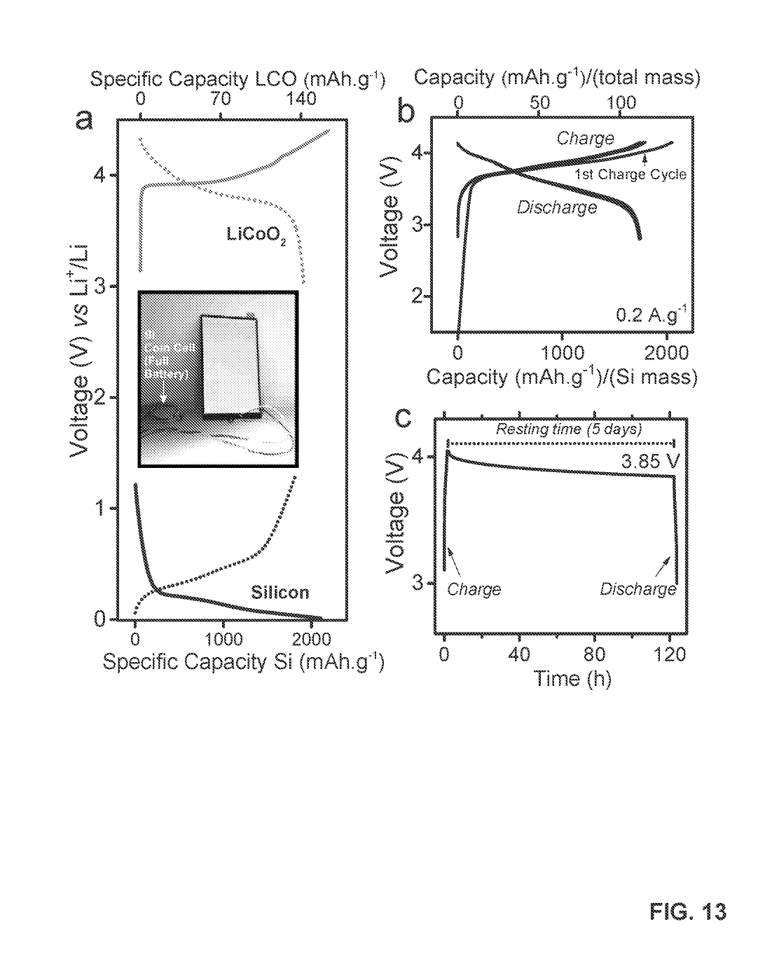

FIG. 13A shows the voltage profile (vs Li⁺/Li) of both Si-NW/GNR anodes and LCO-NW/GNR cathodes. The high difference in terms of specific capacity required an imbalance in terms of the mass of the cathode and anode, proportional to the ratio of their capacities (Qₛᵢ˜12 Q_{LCO}).

The full battery curves (FIG. 13B) are the result of the curves observed in the half-cells. The difference of the full lines in FIG. 13A (discharge of Si and charge of LiCoO₂) gives the charge curves in FIG. 13B, while the dotted curves (charge in Si and discharge of LiCoO₂) resulted in the discharge of the full cell (tested with a rate of 0.2 A g⁻¹). The difference of these curves also gives Applicants the safe voltage limits of charge at 4.05 V and discharge at 2.9V. The flat voltage interval ranges from 4.0 to 3.3 V, with an intermediate value of 3.65 V, close to the values normally found in the graphite/LiCoO₂ systems at 3.7 V.

The aforementioned voltage operation during the discharge is enough to power electronic devices that generally require a higher voltage, such as the LCD screen of smartphones, as presented in the inset of FIG. 13A, in which a commercial LCD screen was powered by a coin cell with a total capacity of 2 mAh. As the capacity of the cathode was much lower than the anode, the specific capacity of the full cell was near the specific capacity of the pure cathode (top axis, FIG. 13B), close to 110 mAh.g⁻¹.

Applicants also observed that the performance of the full batteries were greatly compromised if a fresh Si anode was directly combined with a fresh LiCoO₂ cathode, which happens because of the large irreversible capacity in the first cycle (a common issue in commercial LIBs), thereby leading to the irreversible consumption of Li ions from LiCoO₂. Because of this process associated with the first cycle, the Si-NW/GNR anodes were first cycled in half-cells or pre-lithiated by applying a Li foil wetted with electrolyte over the fresh anode for 2 hours (ACS Nano 2011, 5, 6487). This enabled low irreversible capacity after the first charge cycle of the full cell (FIG. 13B).

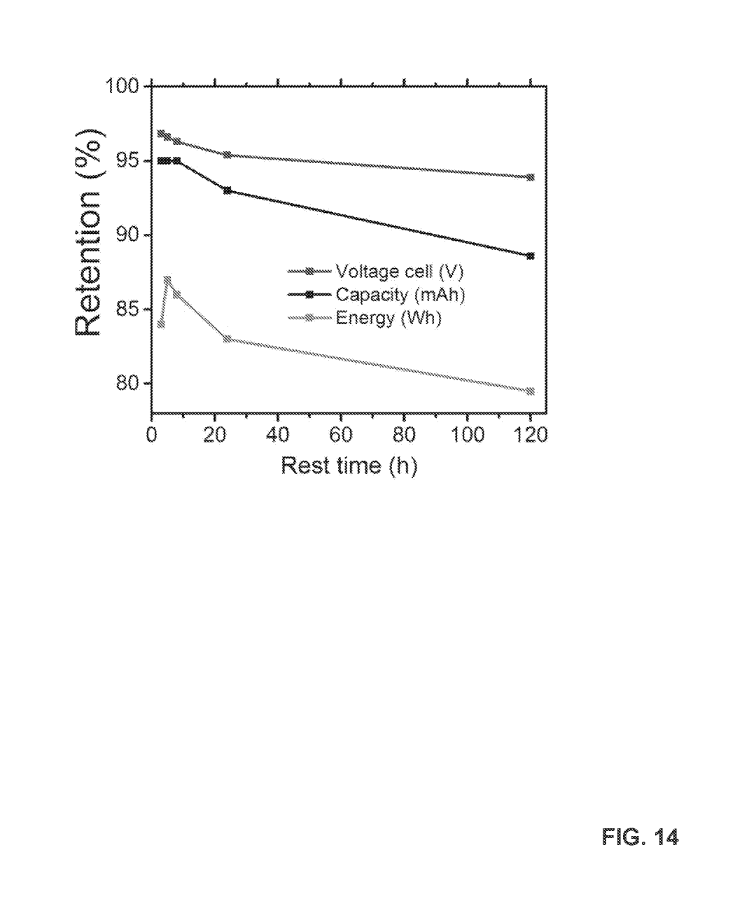

Applicants also tested the self-discharge property of the half-cells (FIG. 13C). The self-discharge measured the stability of the lithiated state of the Si in the full battery without an applied external voltage. After full charge, the full battery presents a good retention of both voltage and capacity, approximately 90% (FIG. 14) after 120 hours.

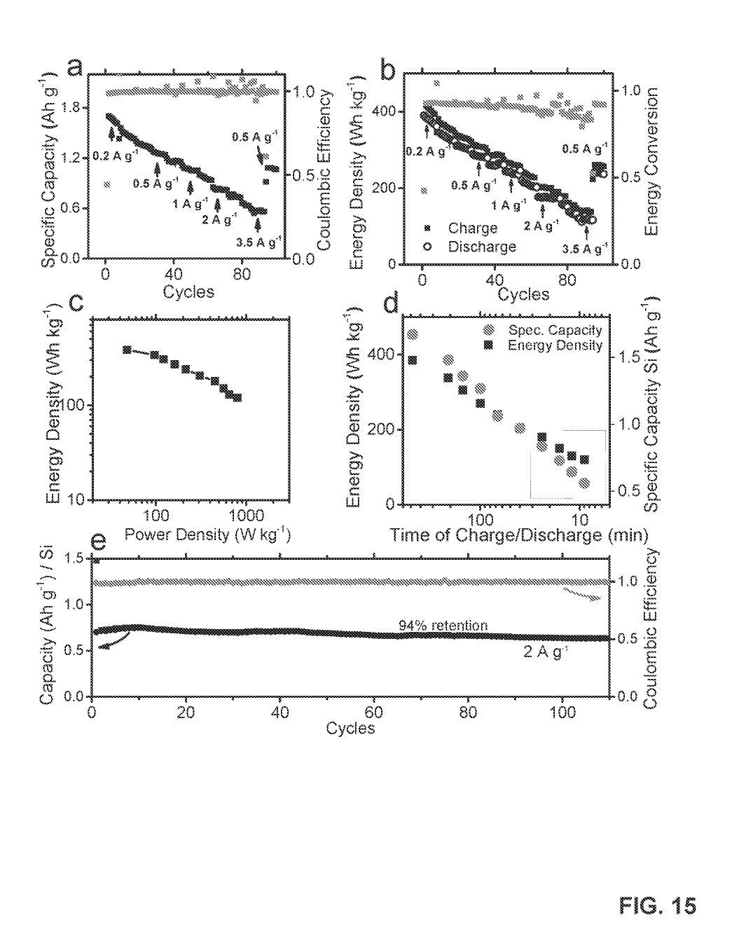

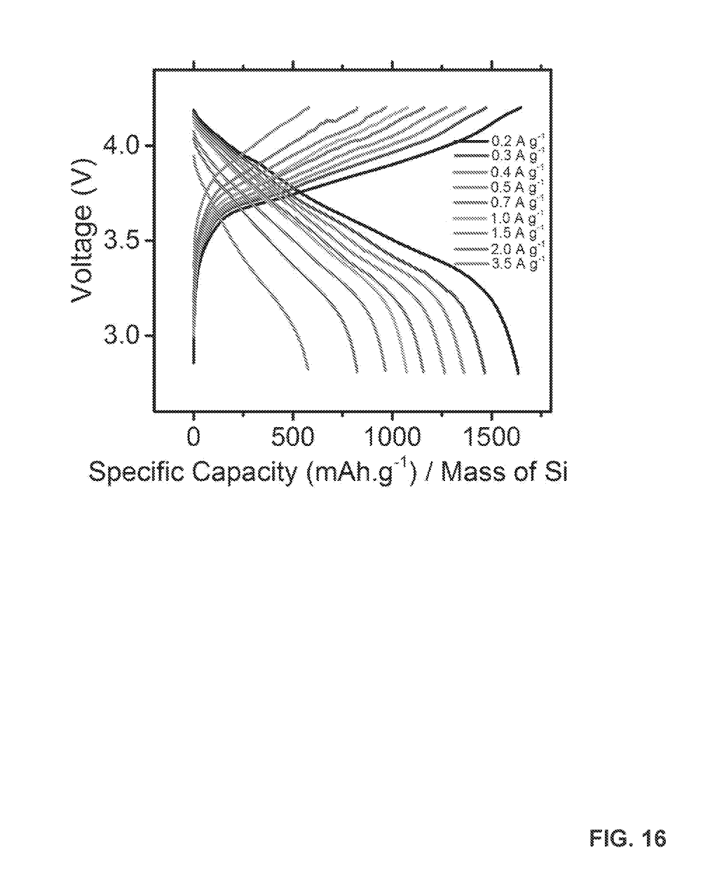

The full cell was further tested for its rate performance and showed faster charging capabilities (FIG. 15). The cycling rate performance is displayed in FIG. 15A, in which the full cell was tested from 0.2 to 3.5 A g⁻¹, and then returned to 0.5 A g⁻¹ (the masses are related to the mass of Si only). The charge/discharge curves are shown in FIG. 16.

The same rate testing is expressed in terms of energy density (FIG. 15B). The specific capacity in FIG. 15A was calculated in terms of Si mass in order to check how much of the capacity of Si tested in the half-cells is useful in the full cell configuration. At lower rates, 70% of the capacity is recovered in the full cell configuration. This proportion is high and is mainly determined by the upper limit of voltage (4.05 V), in order to prevent lithium plating over the Si electrode. The calculated energy density at lower rates (386 Wh kg⁻¹) is one of the highest presented by anodes and is attributed to much less mass of Si in order to match the capacity of the cathode, and also to the similar voltage profile of Si, compared to graphite.

Furthermore, at lower rates, the couloumbic efficiency is above 99.8% and the energy conversion is more than 86%, a significant and high value comparable to other battery technologies. The coulombic efficiency measures the fraction of the amount of charge recovered after the process of charge, while the energy conversion measures the amount of input energy (charge) converted to useful output energy (discharge). These values fluctuated at higher rates in the full cell. However, such values are restored when the full cell is re-tested at lower rates.

The same graphs were expressed in terms of time of charge and discharge (FIG. 15D). Shorter times of charge/discharge of less than 1 hour are compatible with still high capacity and high energy density (200 Wh kg⁻¹) when high rates are employed (i.e., more than 1 A g⁻¹). The stability in the full cell was tested after the rate testing in FIG. 15E at a current density of 2 A g⁻¹. A 94% retention was observed.

The rate testing was also expressed in terms of a Ragone plot (FIG. 15C), in which battery-compatible power densities were combined with high energy density. The results were significantly higher when compared to commercial LIBs, which only show 100-250 Wh kg⁻¹.

### Example 1.9

### Discussion

In this Example, Applicants have designed a filtration-based method to design paper-like structures that contain porous Si-NWs and GNRs. The homogenous conductive path of GNRs is obtained from the several nanowire-nanoribbon contact points created by the paper prepared from these two materials. Compared with other highly complex assembly techniques to prepare Si anodes, this facile and scalable filtration-based method to prepare entangled wire-ribbon films forms a stable anode with superior capabilities in areal and volumetric energy storage capacity and mechanical flexibility.

In addition, Applicants observed that GNRs at high mass loadings (˜20%) had a small contribution to the total volume of Si-NW/GNR papers, enabling a compact and conductive mat-like structure that can be reproduced over large thicknesses, thereby resulting in very high volumetric (˜4000 mAh.cm⁻³) and areal energy storage capacity (up to 11 mAh.cm⁻²). The same results could also be observed in LCO-NW papers with GNRs.

Furthermore, Applicants have demonstrated a high performance full battery with an output voltage of ˜3.65 V. The paper structure prepared from GNRs can percolate effectively through the void spaces of pure Si-NWs or LCO-NWs, thus forming a permanent conductive path that is stable during the change in volume of the Si nanowires. Moreover, this free-standing Si-NW/GNR paper can be combined with other techniques normally reported in the literature to stabilize Si anodes, thus imparting its properties toward direct large-scale applications.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of making an electrically conductive material, said method comprising:
applying nanowires and graphene nanoribbons onto a surface to form a network layer, wherein the network layer comprises interconnected graphene nanoribbons and nanowires.

2. The method of claim 1, wherein the applying occurs by a method selected from the group consisting of filtration, ultrafiltration, coating, spin coating, spraying, spray coating, patterning, mixing, blending, thermal activation, electrochemical deposition, doctor-blade coating, screen printing, gravure printing, direct write printing, inkjet printing, and combinations thereof.

3. The method of claim 1, wherein the applying occurs by filtration.

4. The method of claim 1, wherein the applying comprises:
(a) applying graphene nanoribbons onto the surface to form a graphene nanoribbon layer; and
(b) applying nanowires and graphene nanoribbons onto the graphene nanoribbon layer to form the network layer; and
(c) applying graphene nanoribbons onto the formed network layer to form a second graphene nanoribbon layer on the network layer.

5. (canceled)

6. (canceled)

7. The method of claim 1,
wherein the surface is a porous membrane; and
wherein the nanowires are selected from the group consisting of metal-based nanowires, metal oxide-based nanowires, chalcogenide-based nanowires, silicon-based nanowires, silicon-based nanowires comprising silicon oxides, lithium-based nanowires, sulfur-based nanowires, lithium cobalt oxide-based nanowires, nickel-based nanowires, tin-based nanowires, germanium-based nanowires, metal oxides, porous nanowires, carbon-based nanowires, carbon nanotubes, and combinations thereof.

8. (canceled)

9. (canceled)

10. The method of claim 1, wherein the nanowires comprise lithium-based nanowires selected from the group consisting of lithium oxides, lithium cobalt oxides, lithium nickel oxides, lithium iron oxides, lithium iron phosphates, lithium manganese oxides, lithium oxide alloys, and combinations thereof.

11. (canceled)

12. The method of claim 1, wherein the graphene nanoribbons are selected from the group consisting of functionalized graphene nanoribbons, pristine graphene nanoribbons, doped graphene nanoribbons, graphene oxide nanoribbons, reduced graphene oxide nanoribbons, reduced graphene oxide flakes, graphene nanoribbons derived from split multiwalled carbon nanotubes, and combinations thereof.

13. (canceled)

14. The method of claim 1, wherein the graphene nanoribbons and nanowires define an electrical pathway within the network layer.

15. The method of claim 1, wherein the graphene nanoribbons constitute from about 0.1 wt % to about 50 wt % of the network layer, or
wherein the nanowires constitute from about 40 wt % to about 90 wt % of the network layer.

16. (canceled).

17. (canceled)

18. (canceled)

19. The method of claim 1, wherein the network layer has a thickness ranging from about 1 μm to about 500 μm.

20. The method of claim 1, further comprising a step of removing the formed electrically conductive material from the surface.

21. The method of claim 1, wherein the electrically conductive material is in the form of a structure selected from the group consisting of films, sheets, papers, mats, and combinations thereof.

22. The method of claim 1, wherein the electrically conductive material has a gravimetric energy storage capacity of more than about 500 mAh g⁻¹, an areal energy storage capacity ranging from about 1 mAh cm⁻² to about 10 mAh cm⁻², a volumetric energy storage capacity ranging from about 500 mAh cm⁻³ to about 4,000 mAh cm⁻³, and a conductivity ranging from about 250 nS m⁻¹ to about 3,000 nS m⁻¹.

23. (canceled)

24. (canceled)

25. (canceled)

26. The method of claim 1, further comprising a step of incorporating the electrically conductive material as a component of an electronic device.

27. The method of claim 26, wherein the electronic device is selected from the group consisting of capacitors, lithium-ion capacitors, super capacitors, micro supercapacitors, pseudo capacitors, batteries, lithium-ion batteries, electrodes, conductive electrodes, sensors, photovoltaic devices, photovoltaic cells, electronic circuits, fuel cell devices, thermal management devices, biomedical devices, transistors, water splitting devices, current collectors, and combinations thereof.

28. The method of claim 26, wherein the electronic device is a battery and wherein the battery is selected from the group consisting of micro batteries, lithium-ion batteries, lithium-sulfur batteries, sodium-ion batteries, magnesium-ion batteries, aluminum-ion batteries, and combinations thereof.

29. (canceled)

30. The method of claim 26, wherein the electrically conductive material is utilized as an electrode.

31. The method of claim 30, wherein the network layer serves as the active layer of the electrode.

32. The method of claim 31, wherein the electrically conductive material further comprises a graphene nanoribbon layer associated with the network layer, wherein the graphene nanoribbon layer serves as the current collector of the electrode.

33. The method of claim 26, wherein the electronic device is an energy storage device.

34. The method of claim 33, wherein the energy storage device has an energy density ranging from about 100 Wh.kg⁻¹ to about 1,000 Wh.kg⁻¹ or more than about 400 Wh.kg⁻¹, an operation voltage ranging from about 1 V to about 10 V, and a conversion efficiency of more than about 75%.

35. (canceled)

36. (canceled)

37. (canceled)

38-82. (canceled)
